(19) United States
(12) Patent Application Publication
(10) Pub. No.: US 2004/0012613 A1
(43) Pub. Date: Jan. 22, 2004

(54) Video cloaking and content augmentation

(76) Inventor: Rodger H. Rast, Gold River, CA (US)

Correspondence Address: Raster Corporation, 11230 Gold Express Drive, Gold River, CA, 95670, US

(21) Appl. No.: 10/612,686

(22) Filed: Jul. 1, 2003

Related U.S. Application Data
(60) Provisional application No. 60/394,160, filed on Jul. 1, 2002.

(51) Int. Cl. H04N 7/14; G06T 11/60

(52) U.S. Cl. 345/632; 348/14.01

(57) ABSTRACT

A video cloaking system for actively detecting unwanted background details in response to user selections, and replacing all or portion of the background with user selected content, such as static scenes, animations, or video. The user can represent themselves as they see fit, while hiding the normal background and adding entertainment value. A web enabled content system is also described that is configured to overlay web obtained content for preprogrammed video or audio content when it synchronizes with it. The user can humorous or meaningful content added to the content they view of listen to. Numerous additional system and methods are described.

### CROSS-REFERENCE TO RELATED APPLICATIONS

This application claims priority from U.S. provisional application serial No. 60/394,160 filed on Jul. 1, 2002.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to video transmissions and more particularly to methods and systems of altering video content on the fly.

2. Description of the Background Art

Video conferencing is steadily growing and moving into the mainstream, while set top boxes are gaining popularity while companies search for “killer apps” to foster growth in both sectors and carve out a niche.

One of the problems that arises with the use of videoconferencing, especially for small offices and home offices is that the other party may see more than the sender wants them to see. For example, clutter in the background, items out, persons and things moving in and out of the background, and so forth. Even in a corporate environment they're are often those times, and those things that one doesn't really want the other party to see.

Video as the merger between television and the web has not progressed very far, one generally selects either the web or television. Copyright and artistic license issues arise when broadcasters change prerecorded content to add web enablement features, unless the content is expressly for that purpose. Therefore, little imaginative merging of the web and television has been taking place.

Aspects of the present invention provide solutions to both of these different video content problems, which overcome prior drawbacks.

### SUMMARY OF INVENTION

The present invention addresses indiscriminate content dissemination via videoconferencing, by allowing the user to establish preselected background which safe and can convey the proper setting for the occasion. The system can be utilized with any video conferencing device configured with the processing power to perform the processing. The user need not set up a video stage with a blue screen or make other special accommodations for the video session. The system utilizes signal processing to discern the desired foreground elements from the background and to replace the entire background in real-time with a static, or animated background. The user may even choose to have their appearance augmented, such as appearing to be wearing a Brooks Brothers suit when are actually wearing jeans and a T-Shirt.

Another related aspect allows users to select third party content from the internet to augment televised broadcasting as well as prerecorded content. The broadcasters are constrained in their ability to change prerecorded content, however, fair use allows the end user to do whatever they desire for their own viewing so long as they don't distribute content. Third party content is thereby created for distribution over the internet to augment broadcast or video content. In this way the user can play movies with any added spins they may desire, an experience within an experience. A content source from the web can be stored, and is synchronized with known content wherein it can overlay portions of the content, drop portions of content, an so forth. The web based content being typically the nature of animation, stills, audio, and so forth, the bandwidth requirements are not excessive.

Additional inventive areas described herein include: Camera Equipped Headset, Stage Cuing device, Method Facilitating Political Representation, Prepayment Reserve Credit business model, Automated Change of Address System, Preorder of services & fast foods, Queuing of Remote Individuals with Email, Web Enabled Hair Salon, Spreadsheet Formula Synchronicity, Additional/Alternative save mechanism, Indirect Labeling within Drawing/Text Editors, Incremental Software Preferences, Synched Sound and Typing, Enhanced Stylized Writing, OFXHD Drive (Optical Fixed head drive), Phone billing reminder, and Virtual Extension Phones.

### DETAILED DESCRIPTION OF EMBODIMENT(S)

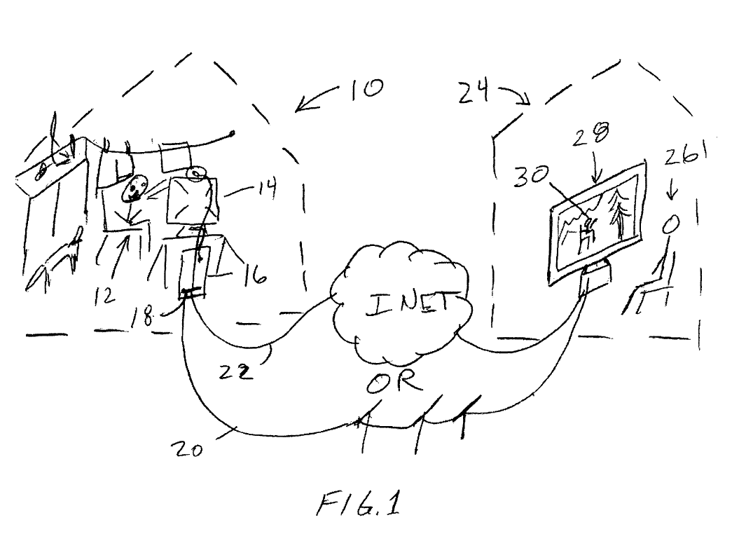

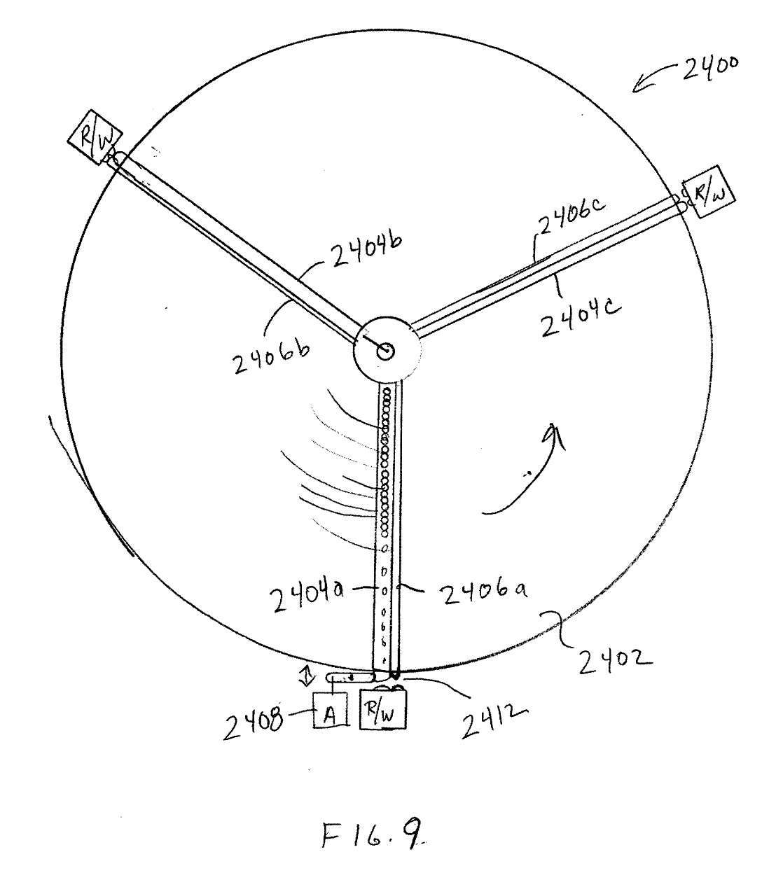

Referring more specifically to the drawings, for illustrative purposes the present invention is embodied in the apparatus generally shown in FIG. 1 through FIG. 12.

Illustrative embodiment(s) of the invention are described herein and depicted in the drawings, the invention is susceptible of embodiment in many forms and it should be understood that the present disclosure is to be considered as an exemplification of the principle aspects of the invention and is not intended to limit the invention to the embodiment(s) illustrated. Various aspects, modes, embodiments, variations, and features may be described throughout the specification which need not be implemented to practice aspects of the invention. Furthermore, preferred elements of the invention may be referred to whose inclusion is generally optional, limited to specific applications or embodiment, or with respect to desired uses, results, cost factors and so forth.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

The present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed.

1.0 Video Cloaking

Allows users to cloak unwanted backgrounds or add other desired elements to the picture being sent. We are quickly approaching the point where sufficient internet bandwidth exists for using video-phone technology over the internet; many larger companies already make use of the technology for having face-to-face meetings remotely.

A problem exists for those who's offices are “esthetically challenged”. Many small office and home offices do not contain the sort of background scenery that the other party is expecting. We'd like to show our face but not the innards of our offices.

Yet now with Video-phone backgrounds every office (home or otherwise) can project a clean smart image. It can be thought of as a HOME or OFFICE VIDEO CLOAKING DEVICE. Your office appears to be whatever you'd like it to be. Nice rows of desks, printers, copy machines, office assistants buzzing in and out, the sound of workers in the background. Or perhaps you want that laid-back look, the sandy surf at Maui, or a sunset at Pacific Palisades. In the mood for comic relief, then a “Dilbert” animation background, with characters hustling about around you, may be what you need. You make the choice from a variety of backgrounds or create and load your own backgrounds. User can also elect what they want blocked, such as items moving through the field of view such as animals, certain portions of the background and so forth. The user can also change the clothing they are depicted with, but not likely to appear realistic unless they are quite still. However, small items like flowers can be displayed on their lapel, and they could do entertaining changes.

This is a hardware/software based product that edits the camera images in real-time before they are transmitted over the Internet, or other communication medium. It will be appreciated that telephones may soon have the processing power necessary to perform the video cloaking when used as a video phone. The user can have a default setting for their phone wherein room assumes a virtual identity to be presented.

FIG. 1 depicts a use scenario, a first building 10, such as a home with user 12 with a video system 14 connected to a computer 16 with an image processing board 18 having signal processing capabilities. The computer able to communicate the video data with an individual 26 located at a remote house, office, or so forth, which is shown watching on a big screen set 30. House 10 has cats roaming around is very untidy, yet since user 12 has enabled video cloaking, user 26 sees user 12 in an idyllic forest setting with trees and birds and is totally disconnected from the reality of the sloppy conditions in home 10.

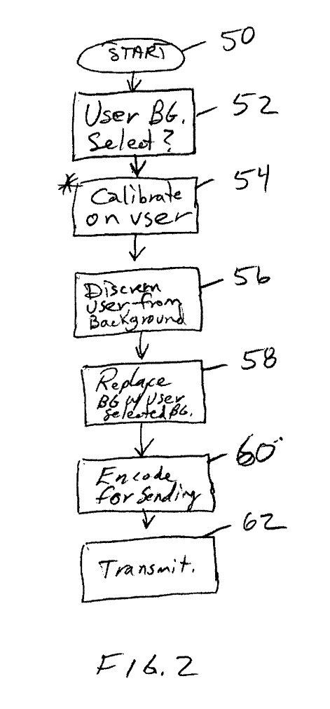

FIG. 2 exemplifies a flowchart of operation, wherein upon starting the session at block 50, the user can select a desired background at block 52 to provide a more pleasant, or more fitting, atmosphere for the other party. A short calibration period 54 can be utilized depending on processing power and algorithms to “learn” the user, preferably having the user briefly move, wherein feature extraction can take place and data stored for discerning the individual. The video stream is activated and the programming discerns the user from the background as per block 56 and then covers all the background or user designated sections, or interruptions, with the user selected background as per block 58. The stream is then properly encoded at block 60 and transmitted to the recipient at block 62.

Video Conference systems are typically purchased with a camera using a CCD imaging chip that nominally outputs NTSC, and a video conference board that accepts the signal and outputs via a one of the ITU standard formats H.32×{320,321,323,324 . . . } The hardware for this would be comprised of a video-conference board with on-board DSP chip and firmware algorithms to perform the conversion.

Video standards that are growing include those from the Motion Picture Experts Group (MPEG), which are capable of reducing bandwidth based on discerning motion vectors from within the frame to frame content. It should be appreciated that the cloaking device of the present invention is may be best executed on hardware that is similar to a real-time MPEG encoder.

It will be appreciated that a number of techniques may be utilized for discerning the person speaking from the background. The relatively static background can be readily detected from the moving foreground, while information about focus, and human characteristics such as detecting the face of the user in combination with boundary scanning to detect wherein the image drops away into the background. It should be considered that the image processing generally commences with the user in view, which can be extended to a couple seconds of “calibration” prior to opening the video channel. The signal processing associated with discerning a known individual in the foreground and the extent of the image of that person is well known in the art.

On a typical video conference camera mounted to a desktop PC—the foreground items would be 12-18 inches from the camera. The background image would normally be at least 3 feet and usually 4 or more feet away.

Two primary methods of providing the background. The first is to take each image and paint in the background, while the second method involves painting the foreground onto a background shot. Either method has a number of items in common.

The software keeps a background image retained from a “calibration setting” picked up when session starts, and creates a composite with a new image as the user starts to answer the call.

Method 1: “Paint in” the Background

After the camera collects each frame the SW discerns the foreground from the background it paints a new background around the foreground image.

That sounds deceptively easy—yet it is not a piece of cake. Heuristic algorithms in the software make use of all the data available: contrast variation, movement, and comparison with the stored composite “real” background, in order to quickly mask the foreground objects from the background. The software also must take into account that in the foreground we may be showing objects as well as our face. The software image matches the current image relative to our fixed composite real background to frame the foreground image but also can use the contrast and movement cues to refine and corroborate choices.

Drawbacks:

Background changes could “leak-through” the cloaked image. Changes such as lighting variation or movement may be difficult to correct for. Speed wise—if the image can not be processed quickly enough then the background cloak may have holes in it to the real background.

Method 2: “Paint” Foreground over Desired Image

Software must select out foreground image and paint it over the desired background.

Drawbacks are that foreground changes would need to be discerned. Center of the image changes, such as expressions etc. and movement should be easy to discern, but what about edge changes such as hair etc. If the contrast is good then easy to pluck out, if not then it won't make much difference that we include a few slightly off-shade pixels. Overall it appears a better approach.

Hardware:

Speed is critical—we are processing the pixels in real-time, although one or more frames behind the camera. Image processing functions are performed all the time in high-power production equipment but this must be a cheap system.

Average Pixel Processing Speed Required, estimate

Assume 800×600 image=480K pixels/image or about 0.5 Mp.

At 30 frames/Sec the pixel process rate=15 Mp/second=66 nS/pixel

The bulk of the screen can be painted at high rate as the image will not move a large distance from one frame to the next.

With the speed of modern DSP chips and gate arrays it should be possible if the hardware and algorithms are properly designed. DSP chips such as Texas Instruments TMS 320C82 can provide up to 300 MIPs which equates to 3 nS/instruction cycle.

The hardware can be setup to provide a set of low-level background functions that can paint from a choice of buffers while high level hardware and firmware handles the edge detection functions for each image. It may make sense to delay the output by at least a frame or two thereby easing the burden on the hardware.

Questions/Assumption:

Assumption: Method layering—it is preferable to use a combination approach to discerning foreground and background so as to increase the accuracy of the operations. A combination of approaches which provides the best fit for least time would become the primary “discernment” algorithm upon which elements of the others would be added and weighted to maximize the speed and accuracy of the resultant rendition. The algorithms can be developed in C/C++ initially for low-speed static testing of results and honing; then created in ASM for the speed needed. (These are small algorithms on a bit by bit basis).

Additional Aspect of the Invention:

Picture in picture, the user can be provided with a small window on the screen to see their own output image when conversing wherein they can check the image that are projecting.

The user can choose to preselect “where they are” in relation to the background selection based on the day of the week and time of day. The system maintains a weekly schedule with background settings for time of day and day of week, allowing the user to set defaults and to alter these with temporary setting such as during special circumstances.

The user can set the system up so that the background selected is responsive to the video number being dialed and/or to caller ID identification on incoming calls. enable the system

Third party backgrounds (static or real) can be created by third parties or the vendor of the equipment wherein these can be downloaded by users in a manner similar to that of screen savers.

The present invention may be practiced utilizing a wide variety of processor configurations and programming, for discerning the user from the background and covering up the original background with the desired image. A number of approaches are available for fulfilling the individual elements of the invention wherein adopting variations would be obvious to one of ordinary skill in the art and would not depart form the teachings of the present invention.

2. WebEnTV

2.1. Introduction

To provide enhanced features when viewing “television” or other similar programming. Numerous program sources exist for the viewing and listening pleasure of users. These program sources are typically either received or played locally from recorded media. Examples of these program sources include broadcast television, cable television, DVD players, CD players, video-cameras, digital cameras, radio, and other forms of media. These programming sources can be received or played by the user traditionally by viewing on a monitor and/or listening over an audio system. During playing of these sources the user is restricted to a limited number of playback options as to how the viewing or listening experience is to take place. The set of options are extended within DVD players as the user can often select different content, such as the use of different foreign language soundtracks. However, the options for the user are generally substantially limited. For example, the muting of commercials has typically been a manual operation although under-performing systems have been devised which can “sometimes” discern the increased distortion associated with the typical gain increases which accompany the broadcast of most commercials. In addition, the copyrights associated with numerous program sources prevent the broadcaster from modifying the content for any specific audience. So although these traditional program sources provide a wealth of material it is not easily controlled by the user.

As can be seen, therefore, the development of a system capable of extending the viewing or listening options afforded a user could provide enhanced enjoyment and utility for users of a wide variety of programming. The system and method for network control and enhancement of program sources in accordance with the present invention satisfies that need, as well as others, and overcomes deficiencies in previously known techniques.

2.2. Description

The present invention is a system and method which provides a number of viewing and listening enhancements for programmed sources as facilitated through a network, such as the internet. It will be appreciated that video enhancement is more technically complex than audio enhancement although following similar mechanisms,. By way of example and not of limitation, the following discussions often describe the more complex video functions wherefrom the simpler audio functions are derived. From a high-level perspective, the system provides these capabilities through controlled mixing of data from the internet with the television broadcast being received and is further capable of providing control of television features themselves when incorporated or interfaced with the television hardware. The system is capable of controlling content as directed by the user, such as the display of a cursor, or directing content in response to data from a web site that is adapted to generate scripting content which can be considered as a stream of web content which is synchronized to events within the broadcast programming source. The mixing or direct control is performed substantially in real-time wherein scan lines of each frame are modified within frame buffers prior to display on the screen.

In general, the system comprises a network receiver control unit (NRCU) which may be implemented within a set-top box, a television receiver, a video player/recorder, a computer, or alternative equipment that is capable of interfacing to the television (or alternative video and/or audio interface to humans), and one or more available internet sites configured to provide control services, such as for television viewing.

By way of example and not of limitation the NRCU is exemplified perhaps most clearly as a set-top box connected to a television set. The NRCU in this instance could typically be connected to an aerial and an internet connection, preferably a 24×7 connection such as a DSL connection, and would of course have an output connection to the television input source. The NRCU may additionally have connections for inputs and outputs from additional sources as well as control channels for additional sources, such as recording and playback devices, yet these would not be required in a basic unit. The NRCU utilizes the data being received from one or more web sites providing the desired scripting content to control and/or modify the source of programmed information. In general, the internet site creates information directly related to each of a portion of the specific television broadcast spectra that is received by the NRCU to modify television broadcasts accordingly. NRCU operation comprises some principle operating modalities which are briefly described and followed-up by a brief implementation overview and utilization examples.

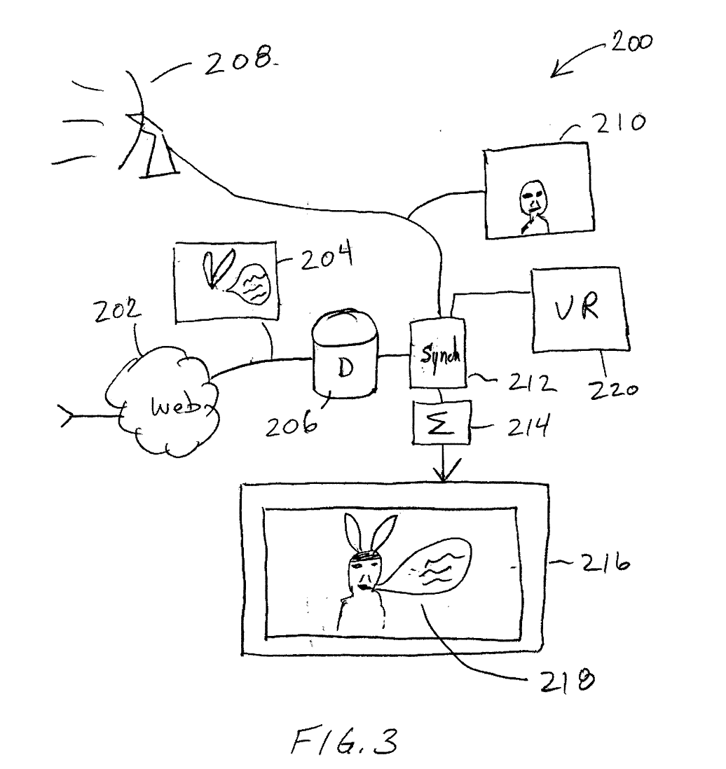

FIG. 3 illustrate an example of the system 200 wherein content for the system is received over the Internet 202, for example an image of donkey ears along with a voice over 204 (shown to indicate example of content from web not the actual presence of another TV set on the line). The content is stored on a hard drive 206. Programmed content is received through a satellite dish 208 (although any content source may be utilized known prerecorded content is generally more amenable to third parties creating auxiliary content). An example of the feed signal is shown 210 as a face-on view of a person. At a time approaching when the show is to be broadcast for which the content was downloaded, a synchronizer 212 activates and begins searching the content for trigger events so that it can synchronize with the content (although is can alternatively be configured to discern patterns and to mix it up by generating its own overlays in response to certain words text, or images). When the synchronization is detected then the web based content is fed into summing circuitry 214, the resultant content seen on screen 216 as the individual from the program but adorned with the bunny ears and speaking in an altered voice or with cartoon thought balloons. It will be appreciated that content can be received from video recorders (VR), and that the overlaid custom content may also be stored by the user on the VR.

One such operating modality is that of providing source control wherein network data is used for selecting program sources and setting program source parameters, i.e. volume, and peripheral control (such as controlling recording devices). Another principle modality is that of content control, wherein network data is used to mix or replace data in the program source under the control of the internet data.

The NRCU comprises a number of hardware elements of which the basic complement of elements are as follows:

user interface—preferably a remote control with on-screen choices

programmable element—preferably one or more microprocessors which are capable of processing instructions, data, and performing DSP functions

memory buffer—for retaining information and programming

real-time clock—for providing rough synchronization (optional)

synchronizer—real-time signature analysis for precisely synchronizing actions to programming content

program source tuner—selection of source channel

audio editing hardware—real-time control of program source audio

video editing hardware—real-time control of program source video

The following are additional optional elements that can add significantly to expanded feature use, as will be described:

program device controller—for peripheral element control

cross-point channel selection matrix—allow use of multiple program channels

program source inputs and outputs—connected into the above matrix

The hardware provides for programmatic control of program sources from a web site over the internet according to user selections. It is preferable that the NRCU in fact be capable of receiving it's core programming from the web site. The NRCU then being capable of constantly being updated to accommodate additional functions and user customized functionality. By way of simplifying the general discussion, the functioning of the NRCU may be likened to that of a graphics design and photo-editing package being performed in real-time in concordance with a command stream generated from a web site to the NRCU. With this simple analogy in mind, it will be readily appreciated that the areas of the background image which constitute the broadcast programming may be modified, or have additional elements overlayed upon it by the content being generated by the web site. The analogy will be carried on to simplify the discussion of the audio and graphical functions, such as editing and pasting which are available within the NRCU.

The preferred method by which the NRCU is able to provide programming content specific information is by way of a page-tree. The NRCU is cognizant of the channel selected, as it has either been selected through the NRCU or the channel information has been transmitted to the website. The channel number constitutes a first index of an array parameter, whose second index is temporal. Data in the array which generally constitutes programming information for the NRCU is downloaded to the NRCU prior to the time it would be associated to the program source, i.e. broadcast data. In this manner the content provided by the web site through a page-tree configured as an array can match any known programming for which information has been provided, as would be beneficial to a broadcaster. Generally in regard to NRCU use for television viewing, the user logs onto a website, preferably through the NRCU, and establishes one or more sets of criterion for viewing.

When the NRCU and television are switched on, data passes between the website and the NRCU to effect customer selections. As delays over the internet are unpredictable, the NRCU is capable of storing command sequences from the web site and even decision matrices based upon the information received from the web site. Preferably, the NRCU will additionally provide the capability to program a video-recorder to record at a given time, but such an arrangement does not consider additional factors and largely acts only as a trigger. Within the present invention, the website can be cognizant of program source broadcasting to render user selection features through the NRCU.

The above hardware description covers the basic block diagram level functions of the device, while an embodiment of the NRCU hardware is described within the detailed description of an embodiment. The NRCU may be used in numerous modalities including the described source control or content control contexts and it will be appreciated that the following are examples of specific applications provided by the NRCU and related to the aforesaid hardware.

Perhaps the simplest aspect of the invention to understand is providing users with the ability to select in advance which programs they prefer to watch. Through accessing the web site, each user would preferably be allowed to select, from a menu associated with their local programming source, the programs they may prefer to watch during a specific time interval, e.g. an evening. The NRCU is then programmed by the web site for the selected shows. Additionally it should be appreciated that recording equipment may additionally be programmed by the mechanism through the NRCU, so that the user may select to record any of the selected programs. The NRCU preferably provides a channel for the selected content, whereupon during viewing that channel may be selected by the remote control of the NRCU to select a set of programming, or type of programming for the channels (and record options) to be routed to the monitor. Each viewer within a household can make their own programming selections and need only then select their associated channel via the NRCU, which preferably has a remote control device associated with it.

The recording devices are controlled by the NRCU through a control interface connection, such as USB or IEEE 1394 bus, and may be connected to receive a single channel as directed by the NRCU or preferably having their own tuner programmed to adjust the tuner for the selected channel. It will be appreciated that although cable companies provide various program menus containing information about their own programming they have no ability to interact with that source. The system and method of the present invention is capable of providing direct and absolute control of any programming source. The user sitting down to watch television could allow the NRCU to scan the channels in a content related order, wherein the user has already provided information as to the types of content they prefer (e.g. old movies, golf, stories about dogs, no soap operas, no talk-shows). Or the user can select a particular type of programming from the remote, such as comedy, or movies. The remote control also can seamlessly bring up an on-screen menu of information received from the website. The menu may augment selections by the remote control, such as providing programming categories for selection or a selectable program listing. The website to which the NRCU is connected having been loaded with information about the programs that are available as well as having a database of related information is in a position to greatly augment user selections.

The NRCU can provide a real-time interface to special events, news stories, stock quotes, and user e-mail. Notification of available content being preferably displayed in a fixed portion of the screen overlaying the scans in that region, such as along the lower border of the screen in similar fashion to a personal computer operating system. The text of selected stock quotes, along with important news headlines could scroll when they meet the user selected criterion, whereas the user could select the site at any time to view the entire story. If the user elected, on a particular content control website, to be provided with e-mail notification, then periodic checks of the user's ISP will return with a notification should e-mail be received. If the user has elected to receive confidential e-mail, then they would be required to enter a password, preferably from the remote control, prior to display of the e-mail on the television screen.

On-line information can be quickly obtained about products and services seen within television broadcast programming, should the user elect to do so. By expanding the programming information supplied by broadcasters, a link matrix that operates similarly to area selection as performed within web sites provides links between active programming content and a set of areas dynamically mapped on the screen to the associated links. The user is then preferably allowed to selects three different levels of on-line information notification (1) none, (2) status field, and (3) status and highlight. If no notification is selected, then the user is not made aware of content available. If status field is selected, then information comprising the number of items or services available is displayed. If the status and highlight is selected then additionally an item for which a link is available is highlighted by the NRCU under command of the website, wherein the screen area associated with the area link map coordinates are altered by the NRCU so that the screen display is visibly altered in that area for a short period of time. A halo effect about the item is one form of notification wherein the coordinate link map is converted to a light-colored border and spread by what can be considered a “smudging effect” when performed in a graphics arts package. The resultant effect being that the new link item is proffered with a surrounding light-colored halo when it is introduced, so that the user is made aware of it as a link. In addition, any large movement of the cursor in either status mode, or status and highlighting mode, causes all the currently linkable areas on the screen to be highlighted. Once the user is made aware of the link they can scroll to areas of the screen to gather information about the item/service. Information gathering in this mode is preferably performed in at least three stages. First stage, as the cursor alights over a portion for which a link is available, a small item name appears unobtrusively on a portion of the screen, such as along the bottom. This first stage informs the user if content is available and of what nature it is. For example, clicking the cursor on the area around a particular German-made sports sedan during a screening of a James Bond 007 movie may bring up information about buying the vehicle, or about a recent web article in which it is featured. The user can determine in the first stage if this is the type of information desired. Second stage, the user clicks on a small icon dropped by stage one near the German-made sports sedan, or the title information provided, and an extended textual information, or limited graphics is provided overlaying a portion of the screen. The user is still able to watch the show yet can determine if they really want full details. In the third stage the user selection preferably opens the full web site associated with the content. It will be appreciated that the selected material information may be shown in a variety of ways including as translucent colored overlays, or in silhouette mode (wherein the background is dropped in deference to the show in progress. At any stage the user is allowed with a single keystroke on the remote control to save the link page with a representative graphic so that they may come back at a later time to peruse the one or more provided links. These saved shots are provided by the NRCU should sufficient buffer space remain, and may be provided off-line on the web-site In situations where only a single link is provided at any one time, the user may select to get information regardless of cursor position. It will be appreciated that items displayed over the received broadcast programming, starting with the cursor, are made possible by web site scripting content that directs NRCU operation to modify portions of the display synchronous to user actions or the received broadcast programming.

In another aspect of the invention the NRCU provides for the automatic muting of repetitive commercials. A problem long without a viable solution is how to mute TV commercials automatically. People have tried to determine boundary between commercial and program so as to perform a mute function but this has been very difficult to do. The NRCU can provide a means for commercial muting that is capable of absolutely discerning commercials such that other programming is not effected. In generally terms, information about presently running commercials is collected up into a database by the company that operates the website to which the NRCU can connect. The NRCU is then periodically programmed by the web site to “know” the signatures of current commercials so that it can be “cut-out” when being received. To understand how the NRCU can be capable of “knowing” about a commercial, it should be recognized that each programming source represents a serial data stream, or multiple streams which may contain a video channel and often a pair of audio channels. Compact digital signatures can be determined for any given section of the data stream, such as a commercial. A signature such as this can take into account the relationships of onscreen colors from one frame to the subsequent frame, the sound, etc. Different companies could in fact create their own set of signature information. It would be anticipated that one or more companies, aside from broadcasters collecting ad revenues, would become providers of such signature data which would be sold to numerous web sites which provide the NRCU information. These compact signatures are downloaded from the web site into the NRCU at any appropriate time. During viewing, the programming source is monitored according to the algorithm of the signature whereupon when a match is found the commercial is muted, and muting terminated when at the end of the commercial. It should also be recognized that the commercial may be alternatively muted by having the NRCU buffer the content of the channel to provide for a look-ahead synchronization interval of sufficient length to allow commercial muting selections from the web site, which are performed in real time, to be communicated to the NRCU. It should also be recognized that the muting may be performed in conjunction with other described features such that the commercial is in essence replaced with desirable web content which may contain various audio and graphics.

In another aspect of the invention the NRCU provides captioned programming, wherein the text is overlayed on the screen image. The user selects a web site to provide the closed-captioning content in the language and style of their choice. Various users have different requirements as to language, reading level, and decisions as to what is deemed objectionable. Unlike current captioning, that is available within the channel itself, this system allows the user to customize how they want the captioning displayed—they can select size, color, translucence, timing, scrolling, and additional features preferences.

In a related aspect of the invention the NRCU replaces the broadcast audio track with a track in a language and style selected by the user. The audio track is continually synchronized with the incoming signal in relation to either the audio being replaced or the video track itself. It will be appreciated that a web script content provider may provide numerous services for a particular language or group, such that these users need not change their web connections.

In still another aspect of the invention the NRCU can perform the functions of a gatekeeper such that undesirable content may be eliminated or circumvented. In recognizing that each person is a product of their dominating thoughts, many viewers and parents are concerned with any adverse psychological impact that may accompany the viewing of broadcast programming containing adverse material. Often adverse content exists even in the prime time channels of large broadcasters, which viewers may wish to limit viewing of. The NRCU can mute or blank the areas considered adverse, or replace it with less offensive content if provided by the broadcaster to the NRCU content provider web site. The NRCU Tags are downloaded from the web site to the NRCU which delineate a signature and range of the content along with replacement data, if available. The NRCU upon identifying the signature which belies the adverse content then overlays sound or graphics as a means of censoring the content.

In a further aspect of the invention the overwrite capability of the NRCU provides a set of features for augmenting program content as selected by the user. According to user selections on the NRCU content provider website, the web site downloads a series of information and graphics in the form of overlays as the program is being viewed. Examples of how this feature may be utilized include the following. Sports fans differ greatly in the amount and type of information they want in regard to their sports program. This technology allows the sports fan to make selections on the appropriate sports web server so that they are provided with the data they desire on screen while viewing the event. In relation to sports, the overlay capability may be used to augment the scenes being viewed as well.

For example, the names of the players could be displayed on screen overlaying their image, one would then know for instance that the first baseman that watched the ball roll by is “Janky Detourney”. As another example, consider the difficulty for many viewers watching a golf tournament to follow the flight of the ball. The data provided by the broadcaster to the web script content provider could be a screen mapping of the ball in flight so that the user can elect to have the NRCU highlight the ball for easier recognition. It will be appreciated that having the user make a large plurality of selections can be cumbersome, and therefore the selections can be generally grouped into categories of viewers. Categorizing in this manner is used, for example, when loading a piece of software on a computer the installer may be asked their choice of installation option: do they want a small installation, a typical installation, or a custom installation? As yet a further example of using this overlay capability, a viewer may elect to watch a version of a show that contains additional information overlayed about the show.

For example they may want historical notes provided when watching a historical docu-drama, or information about the actors. This information could be scrolled unobtrusively along at the bottom of the screen as an overlay on top of the regular programming. In a further example, the user may want a “hysterical” version of a movie. In this case after selecting the version during playing of the movie both visual and audio overlays could be used to enhance the comedic impact. Images and sound bites during the show according to the action could provide a form of professional heckling. For instance, in a classic movie such as “Jaws”—after the shark has taken another victim and begins swimming away he says “Have a nice day” and smiles, or the young boy traumatized by a close encounter with the shark is being wheeled towards his room in the hospital and the mother gives him a rubber shark to play with while he convalesces. The shark could for instance also be providing a wisecracking commentary during the entire movie. The user could select the type of humor they would want overlayed on the show. The overlay content in this case can be provided by either the broadcaster or the NRCU content provider since the majority of the content is available prior to airing of the show, therefore the snippets can be created and tied to signature tags within the program that act as trigger elements to the snippets. During the viewing of a single show their may be numerous websites providing their own types of overlay spins.

Although the preferred use of the NRCU is illustrated for use in controlling television viewing, the NRCU may be used to control any source of audio and/or video; such as cable received audio/video channels; audio/video received by means of an aerial or receiver, such as a satellite dish; sources such as DVD players, CD players, and VCRs. In the case of prerecorded content the user could select the show that is to be viewed from the website and their viewing preferences (which may already be set). The web site then begins downloading scripts to the NRCU for enhancing the broadcast. Preferably, the NRCU will provide integration with peripherals designed to communicate with it, such that when the user plays a DVD or other pre-recorded program source the title and any additional parameters are communicated to the NRCU which can allow the user to control additional features of the peripheral, operate the peripheral in concert with other peripherals, or to use web script content in conjunction with the peripheral. For example, if a user puts in a DVD movie the title and info is sent to the NRCU which can send it on to a web site that may have play options for that movie, the user is spared the task of selecting the movie. The user therefore can get the desired options automatically; for instance they may have a global option set for content not to exceed a “PG-13” rating, whereas any movies viewed and music content could automatically be screened according to that option and cleaned-up to meet the user preference. The NRCU coupled with a web site may also be used for orchestrating the peripherals attached thereto through a single interface that is additionally able to provide links and content additions. As an example the user can control the viewing of music through a television interface provided by the NRCU coupled with a web site. The user can select music playing options for the amplifier as well as setting track order and replays for any CDs that they own. In addition the NRCU provides a perfect medium for the collection of content over the internet, such as MP3 sources, wherein the NRCU can allow playing it directly, or can store purchased content for later play. It will be recognized that the NRCU can transmit content to a RW-DVD system to save tracks for later listening.

Multiple output devices—one screen for the web control the other with the broadcast programming content. Unlike, for instance, separately using a television and a computer the NRCU integrates the link between the two channels, wherein the use of multiple output devices allows the user to have more content simultaneously available. For example: during a sporting event the user could have scores and player information relevant to the event displayed on web site while being provided the capability to control viewing parameters of the television, such as ball highlighting, player identifications, putt-line marking, etc.

By integrating NRCU commands into the broadcast source, the broadcaster can become the source of links to sites that provide the web script content service. Stealing a couple of scan lines from each frame, such as from the bottom, digital data can be stored there, such as text links and web site control language programs for use by the NRCU.

It will be appreciated that the invention may be implemented in a variety of ways for any form of analog or digital television. For use with conventional NTSC television broadcasts and conventional web outputs, the NRCU contains elements of a scan converter along with synchronization circuits, a rendering engine (translations etc), and buffering. The NRCU converts the input from the web into a format compatible with the native format of the television set and upon synchronization conditions being met it overlays portions of signal onto the broadcast signal being received to augment the content. The web script content site may also provide information in a format that is more nearly compatible with the native formats, such as NTSC, such that less processing and fewer artifacts result in the final imaging. This technique can be used with all forms of digital and analog broadcasting within not only the United States but in the remainder of the world.

It will further be appreciated that by employing a suitably powerful CPU in the NRCU and appropriate drivers, the system can provide the functions of a personal computer operating locally (i.e. running application that need not be web hosted scripts such as Java or Perl).

An object of the invention is to enhance the listening and viewing of programmed content through web control and augmentation.

Another object of the invention is to enhance content through user preference selections which control content overlays provided through a web site.

Another object of the invention is to provide a method of selectable content control, such that users may elect to censor or alter objectionable programming.

Further objects and advantages of the invention will be brought out in the following portions of the specification, wherein the detailed description is for the purpose of fully disclosing preferred embodiments of the invention without placing limitations thereon.

3. Camera Equipped Headset

Allows mobile users to communicate their face as well as their voice to a remote individual. For example, a nurse can communicate with a patient wherein the patient can see the face of the nurse on the TV screen, which aid in reassuring them. Also, if used with video cloaking remote persons may communicate their face to the remote person without background element being visible. If used with a small image display, such as a reticular, or glasses mounted miniature display, the mobile user may view the other party as well.

User headset having microphone and earpiece is also configured with a mounted camera, preferably directed at the individual wearing the headset, that may be optionally oriented in other directions. This allows the user to provide visual communications with others—we can understand someone better with pictures than just words. Also they may “show” something instead of just describing it.

The device would be very useful for those working in a tele-service department that has gone to Internet connections with video communication. Also useful for nurses, wherein they could communicate with patients while away from their rooms. The nurses could see and be seen by a patient which would improve efficiency, safety, and patient comfort.

Although the camera is mounted close to the face of the individual the software corrects the distortion to render a generally accurate facial representation.

The signal from the camera is signal processed according to an algorithm created for a known camera position that can expand and contract portions of the image to render a corrected image that is transmitted to the other party. Photo enhancement is well understood in the art for performing adjustments of optical errancy, in particular in the field of astronomy.

Aspects of the invention:

Camera (≧1) attached to said headset

Fixed in a given position, such as toward headset wearer.

Adjustable direction—such as detents, flip over and so forth.

Software for manipulating the close-up image to eliminate the fish-eye distortion and remove the blurry portions of the image. Can use artificial aperture techniques and similar.

SW to remove the headset elements from view.

Orientation sensor adapted for sensing movement of the wearer's head. Software modifies the images to be transmitted, or sends associated parametric information, so that the received image may be altered to represent the head motions, such as nodding, laughing and so forth.

Software according to another aspect may utilize the information about mouth positioning, eye positioning, and general facial characteristics to manipulate an animated image of that person, or any other desired character.

Software according to an aspect of the invention for communicating facial features of said individual for controlling an animated graphic at the receiving end of said communication link. The bandwidth of the transmission may be reduced and the visual communication received will not be affected by adverse conditions at the transmitting (viewed) location.

Software for modifying other aspects of the image, such as lighting, backgrounds, facial blemishes and the like, to create the desired image of said headset wearer to a remote party.

Software according to an aspect of the invention which is adapted for modifying the audio received by said microphone to eliminate spurious communication noise and background noise. Preferably the noise elimination is performed based on a speech model constructed of said first party, so that discernment from ambient noise is more accurately and readily attained. The speech model itself, or parameters thereof, may be transmitted to a remote location wherein the speech model is implemented to attenuate everything that does not fit with the model of the speakers voice.

Viewing device, such as eye-piece, projected image, holographic image, and so forth, wherein two way visual communication may take place.

4. Stage Cuing Device

This aspect provides for synchronizing actors/actresses to be on cue. A computer, PDA, laptop or other programmable element is configured with a communication channel, preferable RF, such as using Bluetooth or another communication standard. The communication may be configured to transmit over a single channel to digital receivers which only activate upon being passed a correct ID code. Preferably the digital receivers comprise very miniature ear mounted digital receivers set to couple the sound through to the ear only if the correct address is detected in the digital RF stream.

Software is provided on the computer system wherein a list of actions to be queued is written in a list with a set of addresses of the communication devices to be triggered or sent a communication, along with the message to be sent if desired. As the play, or other activity requiring queues, such as the Oscar awards, progresses then each item is selectively queued as it should occur. A key, such as a function key or spacebar, may be pressed in succession to trigger each successive simple cues to the associated individuals as their slot arrives. If a person is queued and appears to have “lost their line” then another key is pressed wherein the system automatically transmits audio over their earpiece without the need to look anything up or disrupt the presentation.

5. iDose—Additional Ordering Aspects

This incorporates by reference, the material of the application entitled “System and Method for Providing Temporal Patient Dosing” Ser. No. 10/009,041 filed Nov. 8, 2001 and provisional application serial Nos. 60/172,057 and 60/176,961, filed Dec. 23, 1999 and Jan. 18, 2000 respectively. Additionally PCT application number PCT/US00/35048 filed Dec. 23, 1999 and published Jun. 28, 2001. This section describes aspects for use with that application.

The advantages of the iDose system can be enhanced by the following additional aspects. iDose is an individualized dosing system which allows users to purchase medications and supplements over the internet as doses each containing any desired collection of items, wherein the doses are packetized in the system prior to receipt by the customer.

To increase the convenience of purchasing and using the doses ordered over the internet. A number of enhancements are described for the iDose temporal patient dosing described within the included application.

(1) To prevent a user from having to waste the doses which have not been used:

(A) Extra unattached labels may be included with the date field blank, wherein the user can place the blank labels on doses that were missed, wherein they may remark for a new date, or leave blank. Note that the time the dose is to be taken should be noted on the blank label (wherein extra labels for each dose interval), or more preferably the label be configured so that it does not cover up the time of day the dose is to be taken as marked on the original package. Additionally, the person to whom the dose is intended should not be covered up by the labels.

(B) The interface is set to allow the user to “minus” any doses they don't want from within the dosing schedule they have created. For example, if they had extra doses from a previous month they can use them, such as at the beginning of a month, wherein they need not pay for supplements that they are not using. This aspect lets the user after setting a dose schedule to select a “dose minus” which allows the user to click on any single filled doses to eliminate that dose. (Alternatively, the feature may be implemented by preselecting which doses are not to be filled.) The system preferably keeps track of which doses are “minused” wherein it prints out information as to this with each shipment. An empty package for a dose may be created with a note that the dose was “minused”. In either case it is preferred that dose package shipments indicate if any doses were intentionally left off in response to user selections, so that a user will not be confused.

Typically, the user would “minus” doses at the beginning of a period, such as month, to use up previously unused doses.

6. Earmark−Extensions of Marking Transactions

Additional enhancements relating to the application entitled “Method and System for Earmarking Transactions and Allocating Balance Contributions within a Modular Financial Account”, Ser. No. 09/970,379 filed Oct. 10, 2001 and provisional patent application serial No. 60/214,154 filed Jun. 26, 2000 and the application entitled: “A System and Methods of Maintaining Consumer Privacy During Electronic Transactions” Ser. No. 10/066,495 filed Feb. 02, 2002 and provisional application serial No. 60/266,279 filed Feb. 02, 2001 which are incorporated herein by reference.

Subaccount designators have been generally described for entry on checks and credit cards and their equivalents. A subaccount designation is received from the user before or when executing a transaction, and the subaccount information is passed to the financial institution from which the funds are being dispersed, or deposited. The following expressly describes the designation of a subaccount specifier when using various forms of transaction devices.

Inputting a subaccount designator device on users transaction device—

(1) ATM machine or Electronic Banking System—Transactions may be marked with a subaccount designator when executing transactions within an ATM or other bank connected service device. These may be entered by selecting a field, or selecting an entry from a drop down list of items, or according to any other convenient selection mechanism.

(2) Transaction Appliance—a device configured for allowing a transaction to be sourced for execution. Typically these transaction appliances would be connected over the internet, or other network, for communicating an order. For example a networked computer, a PDA, cellular phone, and other devices that can communicate transaction information such as an account for executing a transaction.

(3) Smart card with an input device wherein a selection is made (a priori) prior to executing a transaction. The selection may be performed on a charge card terminal which read the card. The smart card may also be configured to allow direct entry of the selection. For example, a slider whose position is read by the smart card and included within the transaction. Along the slider may be numbers, designations, indicias, or space for the user to write in their category. The user just slides the slider to the subaccount from which the transaction is to be removed.

(4) Over the phone—subaccount selection may be entered within transactions executed over the phone by submitting a selection value, preferably a short one or two digit designator to the party entering the charge information.

The input device may be implemented on any transaction token, such as a magnetic striped card, or other cards, fobs, identifications, and so forth wherein a sub account specifier may be encoded. For example on a magnetic card a slider or wheel may incorporated which when moved alters a portion of the magnetic stripe to a portion encoded with a sub account specifier.

The user also has the ability to designate transactions to different subaccounts after the transactions have been executed. The following clarifies a number of the vehicles through which these changes may be performed.

(1) Transaction Appliance—The transaction appliance may access banking information from the user wherein a user interface is provided that allows controlling the application of transactions to the various subaccounts.

In some instances the transaction appliance may maintain a record of the charges executed along with the category. This record can be used to maintain a correct rolling balance or used to control or reconcile sub account allocations after transaction execution, directly on the transaction appliance. The subaccount allocations may be controlled on the transaction appliance, which may optionally be used to update the banking records according to the subaccounts if desired.

It will be appreciated that the transaction infrastructure may not ubiquitously adopt the present invention, wherein the control of sub accounts may initially necessitate a post transaction operation by the account owner, or party authorized by the account owner. This may take a number of forms, including, the following are provided by way of example and not of limitation:

(A) Account synchronization and/or reconciliation:

Upon establishing a communication link with the data center associated with the account, such as through an EBPP (Electronic Bill Payment and Presentation) system which is configured for sub account control, the transaction data including sub account specifier is checked against the bank database, and any inconsistent transaction information will be flagged. The user can then remediate the situation. One case of this is when the transaction infrastructure is not configured to pass along the sub account specifier, for whatever reason, wherein the user can direct the EBPP to accept the sub account specifiers that they have selected on the transaction appliance. It will be appreciated that the EBPP will also be flagging any transactions that were not generated by the transaction appliance, (or group of transaction appliances) for the given account, wherein the user can readily note any fraudulent or incorrect charges.

(B) Upload of transaction data:

The transaction data may be uploaded to the data center associated with the given account. This upload may be performed periodically, upon user selection, or upon institutional selection. Furthermore, the process may be either automatic or require intervention by the user.

The data center may utilize the data to immediately alter the sub account categories or perform other actions that are under the unilateral control of the user. It will be appreciated that transaction amounts, dates, payees designations and so forth would not generally be available for change using this process.

(C) Maintaining a Transaction Log:

The transaction information, with sub accounts, may be utilized for maintaining a transaction log, a line item accounting database, or adapted for being imported into a software application, such as a spreadsheet, accounting system, and so forth.

(D) Manual:

The user can simple utilize the information when viewing a statement for the account or when utilizing an associated EBPP.

(2) Application Programming

Various applications executing on a computer system may be utilized to control the metrics of the account, including the sub account categorization. A number of application programs may be created or configured for controlling sub accounts according to the present invention, and other aspects of the given account. The following are provided by way of example and not of limitation:

(A) Integrated into EBPP system, such as provided by the administrator of the account whose metrics are being controlled. Preferably, the EBPP system is adapted to recognize the sub account control.

(B) Accounting application, or similar, preferably having a communication link with the data center associated with said account, or an EBPP interface for said account, that is preferably adapted to recognize the sub account control.

7. PSPid—Logging Purchase Descriptions and/or UPCs

This invention provides enhancements for the pending application entitled “A System and Methods of Maintaining Consumer Privacy During Electronic Transactions” Ser. No. 10/066,495 filed Feb. 02, 2002 and provisional application serial No. 60/266,279 filed Feb. 02, 2001, which are incorporated herein by reference.

We make purchases and see the amounts on our statements, however, we don't know what the expense was for unless we look at a receipt for the purchase. Even when using a transaction agent as described in the patent application included above, the particulars of the elements within the transaction are not known electronically to the user or their bank. If one is tracking expenses then they must enter the information from the receipt in their tracking. This is particularly onerous when the purchase is spread across categories.

The present invention automates the process of providing additional transaction information to the user and/or the bank data base of the users account.

Purchases and payments made electronically under the present invention cause the generation of additional transaction information to aid the user in tracking expenditures.

One aspect of the invention is the generation of purchase information according to categories of expenditures wherein the amount of data per transaction may be reduced to a set of numbers. The categories are defined according to universal category codes, which are similar to the universal product codes, but provide categories of items based on the UPC codes. A set of UCCs make it easy to divide expenses and grants visibility to the account holder.

The information may be sent directly to a PDA, computer, or other active transaction device and/or sent to the bank wherein the user can access additional information about their purchases using on-line banking system or other on-line system. Although the information could be printed on statements this would increase the cost born by banks, they want instead to encourage use of electronic banking and electronic transactions.

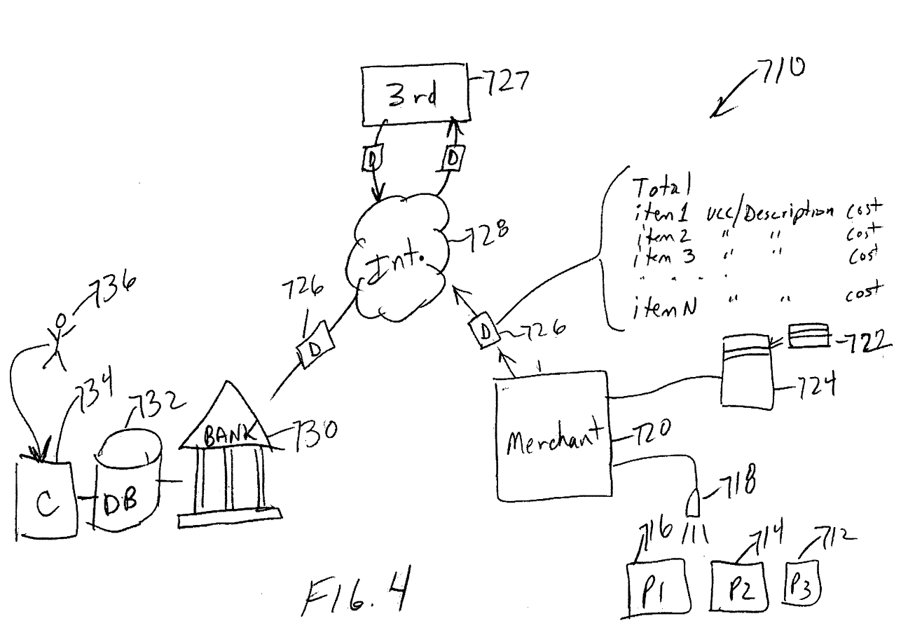

FIG. 4 depicts the system 710 and flow of the process. Purchases 712, 714, 716 are shown being registered by a reader 718, such as a laser scanner, at a merchant location 720. It will be appreciated that goods or services may be purchased and the UPC associated with the purchase may be entered according to any convenient method without departing from the present invention. As the purchases are entered the merchants computer system is looking up each UPC code within the database and retrieving a cost and description for printing on the receipt.

This embodiment of the invention preferably requires adapting the software to store the description from the receipt for communication with the transaction. In addition, or alternatively, a UCC can be looked up for the UPC code so that less information need be transmitted and for providing better categorization use by the end user. Alternatively the UPC itself may be transmitted wherein the UPC would be translated into category codes when accessed by the user.

After all the purchases are entered the purchase transaction is commenced, represented by a charge card 722 being swiped through a card terminal 724. The additional information is then communicated as item information within part of the transaction data “D” 726. Preferably the number of each item and line item cost are preferably communicated in addition to the UCC, UPC, and/or product description. The transaction information is shown passing through a third party card processor 727 on the way to the computer associated with the user's bank 730, or alternatively a credit card company, which can then redirect the charge information to the user directly or the selected destination, such as their bank. It will be appreciated that bank database 732 and associated computer 734 may be accessed by user 736 for viewing transaction information and for allocating expenses across different expense categories or sub accounts within a given account.

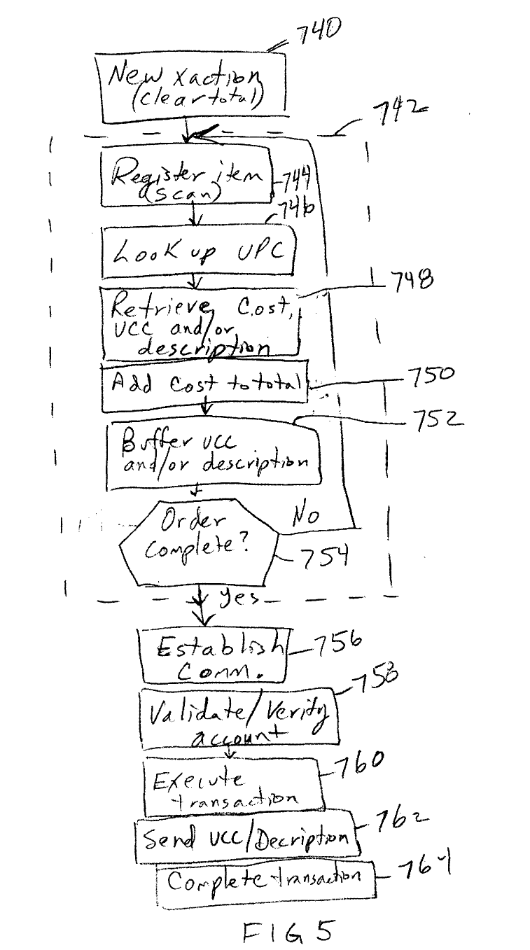

FIG. 5 is a flowchart of the method of the present invention. A new transaction commences 740 at the merchant and all information is reset and prepared to record the transaction. Items are then registered 742 by registering an item 744, looking up its UPC code, retrieving cost and a register tape description and optionally a UCC, 748. The cost for the item (or number of same item) is added to the total 750. The description information, UCC, and/or UPC is then buffered in a storage location that is organized for later transmission at block 152. The process is repeated for each subsequent item until all items have been registered as per block 754, wherein processing of the transaction commences.

Communication is established for executing the transaction at block 156 and the account (credit card, debit card, ATM card, ACH account, or similar) is validated, or verified for the given purchase at block 158. The transaction is then executed at block 160 and the descriptive data (description, UCC, and/or UPC) is communicated to the destination 162 as part of the transaction record. The transaction is then completed at block 164. The user can then access information about the underlying account and can get information about the elements of a specific purchase. The electronic banking system software, or similar, preferably is configured with an interface to allow displaying this additional information. Furthermore the categories of expenses may be extracted from the data (item description, UCC, and/or UPC) so that automatic allocations in specific sub accounts or categories of expense may be performed to spared the user of such tedium.

8. ATM Enhancements for Smart Card Services

To provide extended services for electronic transaction support. It will be appreciated that a new form of cashless ATM machine may be provided which carries no cash yet allows users to receive cash equivalents, for example in the form of deposit tokens into a transaction device such as a Smart Card, PDA, Phone, or similar device configured for executing electronic purchase transactions based on the monetary equivalents stored within the card. These forms of prepaid transaction devices provide a number of advantages over the use of a conventional pre paid cards, credit cards, charge cards, debit cards, ACH based cards, checks, and cash. The cards can be processed at lower fees than credit, charge, or debit card, such as by utilizing the ACH network or other transaction mechanisms.

Furthermore, current ATM machines may be configured for extended services to support the “distribution” of these deposit tokens.

(1) The cashless ATM requires a transaction connection, a display, a keypad, and a port for communicating data so that monetary tokens may be “deposited” within a particular electronic transaction device, such as a Smart Card, PDA, Phone, or similar devices. There is no need for a cash disbursement device, or a deposit envelope receiving device. The port may comprise a slot into which a Smart Card may be inserted so that the ATM machine can write data into the memory of the card. This port may alternatively comprise a communication port, preferably an RF, inductive, optical port, or combinations thereof, over which the “deposit” data may be communicated. It is preferred that if an inductive port, or optical port is utilized which requires close proximity and/or fixed orientation to the port, then a platform is provided having a working surface and a retention ledge facing the user (preventing others from quickly snagging a transaction device), so that a transaction device may be placed there safely while the user executes any desired commands on the ATM machine.

A cashless ATM can be provided at much lower cost than current ATM machines, as it does not require the expensive cash distribution, and deposit receipt hardware. Furthermore, since there is nothing to be stolen from the unit, it does not require a crime proof secure housing and mounting configuration. Although it is preferred that the unit be protected from theft or electronic hacking for illegal

One preferred aspect of the machine is that it becomes disabled from further use in the capacity of an ATM machine upon being tampered with. The unit may even be configured with a GPS and transmitter, wherein it may generate location specific alerts allowing for its ready retrieval. The tamper resistant hardware may be implemented readily, such as incorporating one or more sensors which are responsive to tampering, such as a switching element that is engaged upon the housing of the cashless ATM being compromised, or removed from its mounting location. Upon tampering being detected a data scrambling mechanism, such as FLASH memory reprogramming or erasing may be performed, wherein the functions of the machine may not be reconfigured by a hacker for performing illicit operations. The unit may be rendered generally unworkable in a number of ways, including the incorporation of silicon based explosive chips, (result of recent work with silicon based IC designs) which may be installed within or beneath circuitry so that the system may be completely disabled if warranted.

The transaction connection comprises a secure connection to a transaction network, preferably the proprietary network utilized currently for ATM machines or variants thereof although a conventional network may be utilized with the proviso that it is sufficiently secure.

It should be appreciated that the data being downloaded to the transaction device preferably forms only one half of the data necessary for executing a transaction using the deposit tokens. The other half being account information stored within a card data base associated with the transaction infrastructure. Executing a transaction requires that the two halves of information match up as well as any required forms of user identification, such as PINs and/or biometric information. This two part transaction data is similar to the use of prepaid cards.

Although low value transactions, such as vending machines may be optionally implemented to perform a real time transaction with the transaction device while communicating the transaction details at a later time with data base, which is rather similar to the processing of ACH transactions.

(2) Augmenting a conventional ATM machine with a port for communicating with an electronic transaction device and the associated software for communicating monetary transaction tokens, such as depositing funds within the transaction device.

The apparatus may be generally described as a cashless automated teller machine, comprising:

a display;

a keypad for receiving user entries;

a port adapted for interfacing with a transaction device provided by a user;

a computer adapted with programming for,

establishing communication with said transaction device,

establishing the identity of said user,

supporting a command interface with said display and said keypad for user control of said automated teller machine,

communicating data to said transaction device adapted as a monetary deposit token.

9. Method and Apparatus for Facilitating Political Representation

To facilitate the ability of citizens to communicate with their local representatives and representatives in general. Preferably sponsored by a political party to facilitate communication from the person to their representatives.

A website configured to provide services to voters to enhance their ability to communicate with their representatives, and to encourage feedback to be generated by them toward proper representation.

Location linking with representatives

Automates the task of locating and communicating with representatives

Information about districts and representatives

Submission of letters

Autosending to correct representatives based on your location

*Prompt the party about other areas that could be addressed

2Check boxes about areas that interest the user, with associated information about bills, representatives, and so forth that the person can address. Letters can then be more easily sent to the correct persons. Individuals rarely know where these should be sent.

Current issues

Polling about issues

Donation collections

(Include this with the system to facilitate Temporary InetWorkers)

System for sending local mail from any city

Register and identify oneself with a company performing service.

Communicate information, address info, and shipping info to a central system.

Company prints mail items as specified and mails from local point. Advantages—reduced time to arrival, expedite the process, ship via internet, being able to send mail, such as to representatives within a given district, from outside of that district.

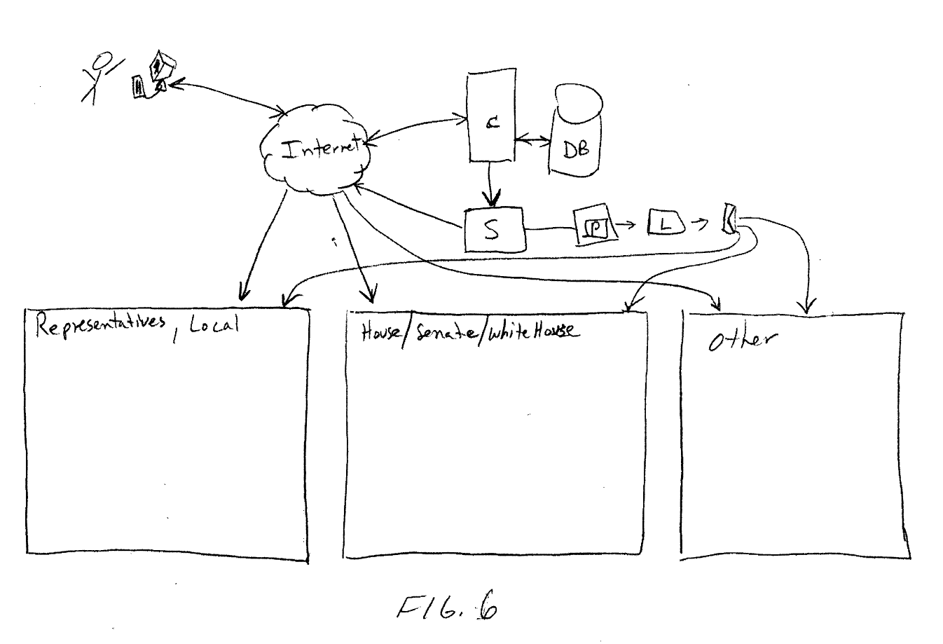

FIG. 6 depicts a connection from a user at a computer through the internet with a computer system and database, such as of a particular political party, such as the Republicans, Democrats, Peace and Freedom, Green Party, etc. The system provides various methods of communicating with political representatives, such as local representatives, house, senate, white house, as well as other politically related organizations, such as lobbyists, committees and selected government positions. The computer system is optionally connected to a letter server configured to allow user to print letters for delivery to selected representatives. The letters may be generated from a single location, or generated from locations dispersed across the Unites States to speed delivery.

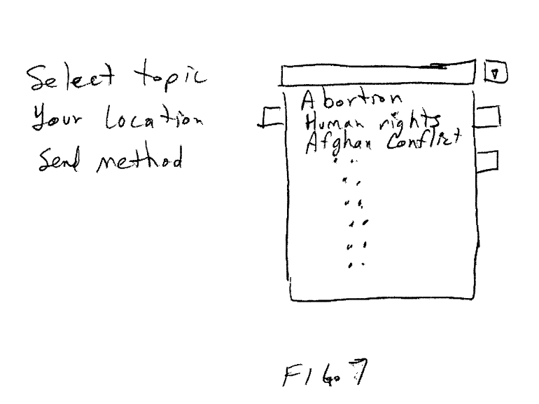

FIG. 7 depicts one of the features supported on the present system, wherein a user can select an area that they have concerns and the system can lead them through a question answer session to determine more clearly what they want to communicate to the representatives. The system can aid the user by providing templates of action letters directed toward that topic, preferably allowing them to edit these letters to customize them to their own sentiments. It can also provide facts pertaining to the issue that the user may incorporate within their letter. The writing of the letter can be provided for on the system by a word processing web application. The system also aids the user in delivering the letter, email, telegram, and so forth to the proper person or persons. The system can save the letter for future use, as this may be an ongoing concern for the user.

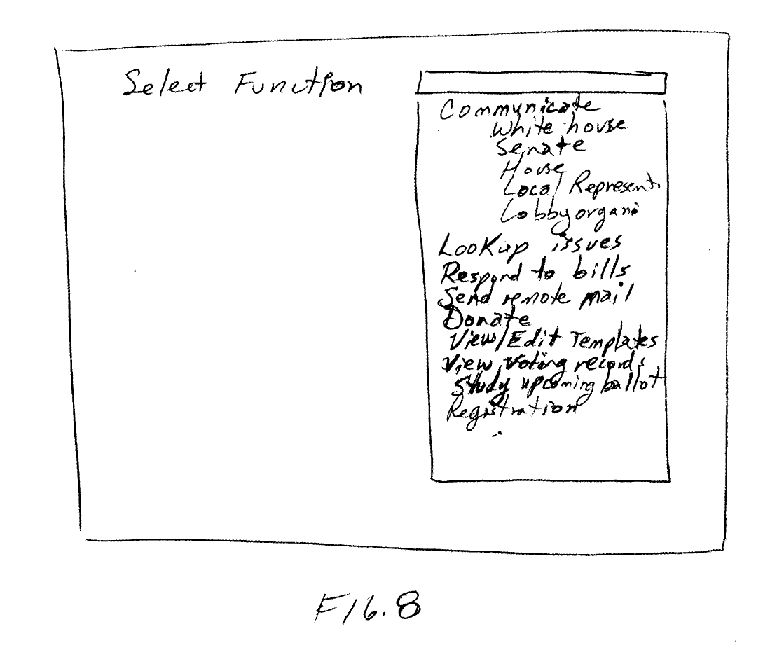

FIG. 8 illustrates a few of the features that may optionally be provided on the present system. The user is allowed to communicate with any political representatives, such as by using email, regular mail, telegrams, and any other desired media. The present system can provide for the automatic generation of printed letters for delivery to a particular representative. These letters may be generated by the system near the representatives and delivered directly, or generated at any other location removed from the user, for delivery to the representative. The system itself looking up the representatives based on the location information provided by the user, or when the user signs up for the service. The user can look up issues of concern, which may then be responded to. Records about different representatives are preferably maintained on the system, wherein the user can keep abreast of how a representative is performing (Voting records, attendance records, and so forth). The user may also study upcoming ballet issues, and pending legislation. The system also can preferably direct users as to how and where to both register to vote, and to cast their ballots. The system also preferably allows users to make donations to a political party, and preferably allows the user to apply their donation toward a particular cause as selected within the web site.

10. Business Model—Prepayment Reserve Credit

The majority of consumers are subject to making periodic payments, such as for credit card payments, mortgages, telephone bills, utility bills, and so forth. The penalty for having a payment registered late is often very costly. For example, a late payment on a credit card is typically subject to a $29 fee and often the loss of any preferential interest rates being honored. Consumers are very busy and it is easy to inadvertently send a payment off late or misplace a bill and miss sending a payment.

Even a consumer that regularly pays an amount, such as for a credit card, that is far in excess of the regular minimum payment is subject to the stiff penalties if a payment is late.

Requiring billing institutions to institute a “prepayment credit reserve” wherein the consumer is allowed to prepay over and above the bill wherein the amount is held in a credit reserve for their account. Preferably the consumer can set the amount of the prepayment reserve. For example, for a credit card having a monthly minimum payment (at a particular time) which is a maximum of $350 the consumer may want to set a reserve amount of $350.

If the payment is not received by the required payment date, then money is deducted from the reserve account. Each statement reflects the amount of money with the reserve account. The consumer may alternatively elect to make a lump-sum payment to the reserve account, such as for a gas bill (average $12 month) wherein they can save time on sending monthly payments.

Often billing companies, in particular charge-card companies, have odd bill closing dates, (long delays in processing received bills that they then classify as late. Many class action suits have resulted from this lately.

Consumers then need not synchronize their bill payments with the creditor billing periods. They can pay at any time within the period covered by their reserve account.

Interest: As only a very meager cost is associated with maintaining another field to a computer record, the money in the reserve account over a given amount, such as $100 should preferably accrue interest, such as at ½ the prime rate. Not enough to induce use as a savings account, but consumer loss of interest is lessened somewhat. [Reason for cap: eliminate interest calculations on amounts wherein overhead cost to calculate is greater than interest gained.]

11. Ordering & Submitting Information Online

To simplify the processing of paperwork. Some organization require that users acquire and submit copies of existing documents according to qualify for certain considerations. One example of this is the United States Patent and Trademark Office that requires users to submit copies of relevant patents and articles which are to be listed on an IDS statement submitted in association with an application. The current process involves high mail and processing costs, while it does not generate the maximum profits to the organization.

The present invention allows the user to simultaneously order documents for use by the organization to which they are to be used, this reduces the overhead and mailing costs to the individual while increasing profits to the organization. The organization sets up a web site through which a particular document action is to be performed, and provides a mechanism by which the user can order the necessary items (documents, files, audio files, etc.) in conjunction with filling out the necessary form, wherein the individual performs the action on-line and orders the necessary information directly from the party to whom the information is to be submitted. It will be appreciated that the organization may be ordering the material from a third party, however, this may be made transparent to the user. The user can then fill out a form with a list of items to be submitted, and select to have those items ordered for use with the form. This simplifies the process for the user and they need not go out and find the resources, order them, receive them, repackage them, ship them, with forms to the organization.

A good example can be made for using the system for generating an IDS (information disclosure statement) online. The user can enter in patent numbers, or alternatively selected patents found in a search for inclusion in the IDS form. The user can elect to have the USPTO print these selected patents, for a fee, and enter the IDS with the printed patents into the case. The user is therefore spared the overhead of receiving, copying, and resending patents, (that may have been purchased from the USPTO anyway) back to the USPTO for entry with an IDS statement. Furthermore, it is preferable that the user can obtain an electronic copy of the ordered patents for their own records, by accessing a download section on the web site wherefrom the ordered patents are available for download by the user for at least a limited time period. The web site can be augmented to link with a document, and new retrieval system, so that the user can extend this paradigm to allow entering document information into the IDS and placing an order for the subject document to be entered into the IDS. The user therefore could perform a search and while they are performing it they select patents, or other non-patent documents, to be entered into the IDS for the application. They then perform a financial transaction which covers the cost of printing the patents or other documents at the USPTO, wherein their IDS submission is completed entirely on line. If the user has not yet filed an application, they should be allowed to retain the filled out IDS statement (before or after ordering relevant patents), wherein they may return to their own area on the web site at a later time to actually submit the IDS statement once the application is submitted.

It will be appreciated that the same scenario is applicable to a few other situations in which a plurality of materials, such as documents, files, records, graphics, audio files, clips, transcripts, and so forth need to be submitted in order to process an application or perform another service on behalf of the user.

The system may be implemented on a web server, that allows the user to enter data in the forms, or indirectly select the needed material, such as by searching. The system is linked to a document retrieval system wherein the items selected for retrieval within the form may be paid for and fulfilled via the link. It will be appreciated that one or ordinary skill in the art can readily implement the present invention using any convenient web programming language, wherein no figures are necessary for understanding how to perform the implementation.

12. Accounting Services & Tracking Time/Integrated Billing within an EBS

The present invention is very well suited for use with the invention entitled “Earmark—Extensions of marking transactions” and “PSPid—Logging of Universal Category Codes (UCC)” which are described elsewhere in this provisional patent application and included herein by reference.

The present invention is also well suited to be used in combination with features described in the following patent applications: “Method and System for Earmarking Transactions and Allocating Balance Contributions within a Modular Financial Account”, Ser. No. 09/970,379 filed Oct. 10, 2001 and provisional patent application serial No. 60/214,154 filed Jun. 26, 2000 along with the patent application entitled “A System and Method of Maintaining Consumer Privacy During Electronic Transactions” Ser. No. 10/066,495 filed Feb. 2, 2002 and provisional application 60/266,279 filed Feb. 2, 2001, and also patent application entitled “Apparatus and Methods of Providing Enhanced Control for Consumers” which describes implementations of a timing device for collecting billing time information, Ser. No. 10/039,709 and provisional application serial No. 60/301,193 filed Jun. 26, 2001; ALL of which are included herein by reference.

To facilitate small business record keeping, and to increase bank profits.

To simplify record keeping and managing a business in general, banks are increasingly providing extended services to their clients.

Everyone in a small business is often working on revenue producing activities, wherein the accounting must be handled by an outside party, or done grudgingly by one of the primaries of the small business. Reducing the time and efforts involved in performing the accounting would go a long way toward helping small businesses.

Small businesses are often required to track time billings, as well as expenditures for both personnel and purchases. The present invention allows the user to perform these function within the automated on-line banking system. It will be appreciated that numerous pieces of information necessary for tracking time and expenses are available in relation to the transactions that pass through the associated account. It thereby makes sense to provide extensions to the electronic banking application that allow the user to track, download, or otherwise transfer information to and from an application associated with the electronic banking system wherein these accounting duties are minimized. It will be appreciated that no longer will the parties need to enter data from bank records to an accounting system, or vice versa.

The system can operate on a conventional bank computer system that is configured for performing user control of electronic banking. The software is then augmented with additional functions. These functions can be added directly to the electronic banking system (EBS) application, or portions of them may be provided as small standalone applications by the bank for use by the user. For example, a small time tracking application, or device, may be utilized for recording the times to be billed to clients. This information may be directly passed to the EBS which can allow the user to track time and billings to the client. The client can then track expenses, generate bills to the client, and so forth using the time tracking and accounting features of this extended EBS.

It will be appreciated that the bank can increase their revenues by providing extended services to the small business person, such as bill processing, bill collection, employee payroll, and so forth. The user may already be sending out payments to suppliers with EBS, and the effectiveness of the overall record keeping can be increased dramatically by making the EBS a focal point for these additional non-traditional banking services.

With the user performing all accounting on the EBS, it would be very convenient for the user to use bank services, wherein they need not get outside services and then bother with entering information in relation to the use of those outside services into their EBS account. The EBS could provide a “one-stop” application for handling all of the financial services needs of a small company, while greatly reducing the required book keeping overhead to which the business owner is subjected.

The accounting portion can allow the user to enter non-account related transactions, or download them from other applications, such as within their own PC, so that the bank transactions records can be extended with additional line items into a journal wherein all relevant transaction information is retained. The automatic extension of banking information is described in the application regarding “transaction earmarking” as included herein, which allows the user to segment their account to simplify the accounting process. The present invention may be used with that system, or implemented independently. Records for payroll can be optionally tied into the system wherein the tracking of employee time and salaries is connected to the banking system. The user can have the bank perform the services to “cut the checks” and may optionally perform automatic payments for the payroll taxes and other payroll related functions that can significantly impact the small business person.

In addition, the bank can perform as a aggregator, wherein electronic information from other sources can be electronically passed to the bank and entered into the database associated with the EBS. For example, a business may have lines of credit, credit cards, or other outside services, that upon being directed by the user would direct electronic copies of financial information in a given format to the bank for automatic inclusion within the statements of the business owner. The accounting system of the EBS can then automatically track categories of expenses, such as finance charges, and expenditure information for transactions not performed in relation to the banks direct services (checks, credit cards, and so forth). It will be appreciated that currently a bookkeeper is often hired that aggregates this information by reading it from printed statements, including bank statements, charge card statements, payroll statements, and so forth and must laboriously (and correctly) enter all this information by hand prior to even commencing with operations to track the finances of the business.

13. SmartS rvices.com or SmartWork.com

Methods and systems of enlisting temporary work to be performed over the internet. Qualification of each “workers” is preferably performed wherein the skills of the worker are known at the outset. Preferably a training path is provided wherein the workers can learn necessary skills to upgrade their standing on the system. This allows those persons, such as retired parties, those in other countries and so forth

By way of Example:

SmartServices.com—Site for performing internet related services.

SmartWork.com—Site for enlisting workers and doling out the work.

The invention provides for establishing web sites that provide knowledge services, secretarial services, and other electronic based services to businesses. The workers work from their computers connected to the internet, they do searches collect data, enter information, correct scanned information, perform various secretarial services, make calls, and so forth, from their computers. The companies are able to pay for these services as one time expenses and need not be burdened with finding and bringing in an actual worker. The system effectively turns work into a video game, wherein the user racks up eDollar points, garners certificates of qualification for different forms of services, and does actual tasks for companies that pay the company operating the websites for having the tasks performed.

The workers are preferably paid in eDollars which can be cashed for real money. The intent is that many people have time on their hands and would enjoy being productive, but don't want to commit to a “real job”. Others may have some extra time they could devote to earning extra money, or learning while earning extra money, but don't have enough time, or inclination to take a second job. There are many millions of workers that could fill in the gaps to perform various services in an economical manner for a variety of small and large companies

Workers must qualify for certain tasks in stages. The first stage is to perform a canned job—to which results are easily checked and feedback given to the user. Some pro-bono jobs for non-profit organizations may be put forth for training workers in an area of skill, such as searching for articles relating to an area of interest. The quality of the resultant work need not be substandard, in fact is may be excellent as a number of persons may have performed the task wherein the result is based on the work of many individuals attempting to do their best so as to become qualified for performing higher level services. Workers in training can also work at reduced-wages, after the initial training during an apprenticeship until they are certified. Reduced wages are necessary because multiple persons are set to do the same task with result comparisons performed against the other workers. Workers with higher certifications in an area will be allowed to provide services as a mentor, wherein they review work and pass tips to the person that performed the work to aid them in doing a better job next time, they will be compensated of course for this task. The worker is given feedback on the work, and tips from time to time. If the worker needs more training they can check into the training site which provides guidance on performing each of the tasks provided within the service.

The system maintains information about each worker, relative skills, reliability, and so forth, which can all be factored in to determine what work the individual is qualified for and responsible enough for.

Various confidential and non-confidential service offerings allows people to get specific types of information collected, with some level of assurance that a reasonable job will be done.

Workers can see how many eDollars they can rack up—it matters not if the workers are retired senior citizens or children—so long as they learn the requisite skills in order to perform the work.

The system will be truly equal opportunity—with every one being equal insofar as race, creed, color, religion, etc. The only distinguishing characteristic is the ability to perform the task.

Political action committees may put up money for people to copy a letter and send to a congressman, etc.

Excellent for senior citizens, the disabled, school groups, and so forth.

Possible Problem: One would need to assure that the government would not get in the way because of some nefarious “labor law” issues. The people doing over a certain amount could be given W-2s, if necessary—but this would start adding overhead to the process. The model is that each individual is a consultant responsible for their own taxes.

Search Engine for use with SmartWork.com—in order to aid the individuals in honing their skills and to more easily oversee quality the worker-user would preferably perform all their computer based work on the systems provided by the web site, such as the performing of searches (tracks time for the searches, links viewed and checked, downloads etc). This helps keep the persons on track toward their goals.

It will be appreciated that earning a certification, need not only be applicable for use on this system, as it is contemplated that these certificates would become ubiquitous and that individuals could then use their certificated status at certain tasks to obtain a permanent job at an employer, thereby bringing more individuals to productive working status.

14. Automated Change of Address System (+PSPiD)

This application includes by reference a related application entitled “A System and Methods of Maintaining Consumer Privacy During Electronic Transactions” Ser. No. 10/066,495 filed Feb. 02, 2002 and provisional application serial No. 60/266,279 filed Feb. 02, 2001.

Provide a mechanism that simplifies changing of an address for individuals. Currently individuals must change their Driver's license, they must notify the Post-Office, they must change their voter registrations, they must go have passport updated, they must notify all their insurance companies, they must notify bank to have new checks printed, they must send updated info to each organization to which they belong, they must send info to each magazine and publication they subscribe to, and they must notify every financial institution and creditor with which they deal. Doing so can be a lengthy exercise that can now be overcome electronically.

Additionally companies currently receive handwritten change of address information that must be entered into their system. Mistakes entered in to the system are costly. Companies have no assurance now that the address change is valid, so many require some form of validation from the person making the change.

A centralized repository for changing address information. The system only operates to notify the parties under the direction of the consumer, whereas no privacy issue arises. It will be recognized that the parties being notified already have the address for the consumer, however, this address will be no good after the change. A preferred aspect of the system is that it tie into some verifiable, or pseudo verified address, such that parties would not use the system to mislead the organizations being notified as to the new address. By way of example and not limitation the following describes this verifiable entity as being the Department of Motor Vehicles, or other agency involved with licensing in the particular state.

The invention may be practiced in conjunction with the consumer privacy invention described above which is included herein by reference.

Companies that have a relationship with a consumer submit information to the database, such as at the drivers license records system, or a postal service record system. These companies include government ties (unemployment, tax, etc.), voter registrations, licensing (drivers, trade, etc.), magazine subscriptions, credit cards, banks, church, synagogue, mosque, organizations within other states (countries) having ties to the individual (they may have property or business interests in these other areas), or any other organization that has a close relationship with the consumer. Just being on the companies mailing list would preferably not qualify, or would at least be ranked at the bottom of the heap, so that the consumer could elect to not receive solicitations from any of these entities. They may want information (solicitations) from certain entities though and can select them. Preferably, they would also be allowed to search for information from companies that they have no current ties with. For example, in moving into a home they may want the local Hardware store to put them on their mailing list. Each institution pays only a modest fee for the information they receive from the agency.

The consumer information preferably includes the following: Information about the consumer including name, address, phone, *SSN, and other optional fields that help match that name up with the actual individual consumer. Information about the entity including: name, location, change of address submission link, name as known to the consumer, and relationship with consumer.

The consumer information is sorted per consumer to match the records from the organization with a consumer. If no match is found then a notice is preferably sent back to organization so that it may correct its records. After sorting, the record for each consumer includes a list of companies with “supposed” ties with the consumer. The database of course should retain the minimum information for each record, for example a code for association, and a code for the company name. However, when the user views the list these code fields will link to the information about the company so the user knows fully about each company.

The consumer, upon changing their address has the option to have any or all of these companies notified. This can be performed at an agency, such as the DMV, or over the internet. It is preferable that the user be given a temporarily valid access code, such as userid and password, so that other parties will not be able to access the information of others to send notices to all parties.

Consumer accesses a kiosk, or an internet server using the access code and a list of companies that they are associated with show up on the screen. The user can click a check box next to the name of any company they wish to send an updated notice to. They can also elect to select all companies and then go back through and uncheck any companies that are questionable. No change of address notice will be sent to companies unless so directed by the consumer. If the consumer sees companies listing possibly erroneous ties to the consumer, then they can flag these as questionable, wherein these reports can be investigated and companies dropped, fined, and so forth should they attempt to abuse the system.

After the consumer has selected that parties to be notified the system prints out a list of the companies that are being notified and preferably those that are not being notified. This list should include contact information for each company should the user later decide that they really should contact a particular company that was left from the list. The system then notifies each of the companies using the link provided wherein the new address is communicated and optionally the phone number, and email address, at the discretion of the user. The user can specify under what conditions the email address, phone number are to be used. If used in conjunction with the included privacy system application, the system can generate indirect links to the consumer for email, or both phone and address, wherein the company will be absolutely restricted from gaining unwanted access to the consumer or of selling the consumer information to additional parties. At consumer discretion the list is sent to their email address replete with the links, wherein the consumer after determining that they do indeed have ties to the companies, can then click on the links to have the new information automatically sent to these companies.

15. Preorder of Services & Fast Foods

Ordering food and paying by internet, allows the consumer to head right to a pickup line without the need to wait. Also can simplify the problems with “who gets the check” when it comes to other “sit down” restaurants.

The user accesses the web site for the establishment and the type of processing generally depends on the type of eating establishment.

(1) Fast Food:

They may elect to preorder, such as at a fast food restaurant, wherein they may choose their menu items (for themselves, a family, a group, and so forth). They enter a time and restaurant location which sets the when and where for the order. The order is then optionally checked with the establishment (particularly if seasonal items are selected), via posting information on an order display at the restaurant, a worker can verify if these items are truly on the menu and available. They then process a financial transaction for the amount, wherein the food order has been paid for. The order is then posted for fulfillment at the restaurant with a pick up time and a unique identifier for the order. The identifier may be a number, phrase, picture, etc. The identifier may be printed out on a slip of paper so that the individual may submit this at the pick up line to receive their food order.

(2) Conventional restaurant:

Similar to the above, however, the user may not want to place the order, rather they want their guests to select their own dishes. The user in this case can submit a reservation time, number of persons, and then prepay for the meal, preferably with an upper dollar limit. The upper limit is a security thing to protect the consumer from mistakes. If the upper limit is exceeded then the transaction is typically nulled and the consumer is required to pay conventionally.

The consumer can preferably preorder appetizers, wines, etc, so that these will be brought to the table without the need to place a specific order for them.

The consumer can select how a tip will be paid {fixed amount added at time of order, cash at the table, and so forth}.

Upon arrival the user would identify themselves, such as by name to the maitre de, wherein their selections would be pulled up. An optional identifier could be used, such as a code phrase, or submitting a paper order copy.

The party is seated and may order conventionally. At the end of the meal the person placing the order is handed a receipt with the total so that they won't have any surprises later. The server can ask for “John Doe” or whomever placed the order. No one can chime in to try and pay for the meal, and other nonsense.

The consumer can pay the tip at the table, or supply an additional amount above that which they elected to pay automatically. The amount is then deducted from the account of the consumer and both restaurant and consumer are happy. It may be preferably, or necessary, for the establishment to register the signature of the individual for executing the charge card transactions, wherein the named party would be given a charge slip to be signed. This may be required if the restaurant is not setup to process electronic transactions.

Alternatively, the named person may be called away from the table for the purpose of handling the transaction if this is what they have elected to do. They can even optionally indicate for what ostensible purpose they are being called away.

16. Queuing of Remote Individuals with Email

A number of services only have the resources to execute a fixed number of operations in a given period of time. For example, transactions, customer service phonecalls, haircuts, and so forth. It is often difficult to queue up the parties in a fair manner while minimizing overhead.

Consider the following simple example—a hair salon in a large office complex whose business must be organized on first come first serve. Patrons not wanting to wait must rely on calling the shop or visiting it in person, either of which wastes the time of the patron and the shop's operators. Currently no simple mechanism exists for remediating this situation.

An autoresponder can be configured for the email address of the business which provides a patron with status information and a queuing mechanism to facilitate the ordering of clients.

In use, a patron interested in the service (haircut) generates an email to the business with a subject line stating the service, i.e. “XYZ Salon: haircut” or “XYZ Salon: haircut by Dan”.

Email from patron is automatically read and checked by mail client of salon. Upon finding the tag line “XYZ Salon:” followed by “haircut” and optional person “Dan” it generates a read of a service selector within the hair salon, that is set by the operators to indicate (a) if any stylists are available, if no stylist is specified; and or if the specified stylist is available, and (b) if not available, then the expected time before they will become available is provided. The patron thereby has a “ballpark” idea of the timeframe by which service may be expected.

The selector can be implemented as a single knob for each station, or a set of controls (such as up/down). Non-specific requests are processed by retrieving a value for the shortest duration.

(Optional Queuing)

If the service was not available at the time the patron sent the email, then their email is placed on a queue list in the order of receipt. Preferably, the elements within the queue list are displayed as a row of labeled icons on a computer screen, or other annunciating device. When the service is about to become available, such as within 5-10 minutes, then a reply is sent to the patron which indicates that the service will be available within a given timeframe. Users that plan on heading right down, can immediately respond to the email to alert that stylist that they are on the way. If no response is returned within a few minutes, then their name can be removed from the queue and other people alerted.

A party that has missed their opportunity must then requeue up for the next chance at the service. (it will be appreciated that opportunities that rely on time delays are most suitable for email communication within intranets, or a small area of the local internet wherein delays are small.

Patrons wishing to use the service can be periodically sent an email that contains the information on how to use it, furthermore specials may be incorporated within the email which are registered by the mail reader within the target system.

17. Web Enabled Hair Salon

This includes by reference the related teachings “Queuing of Remote Individuals with Email”. To enable salon patrons to better control the hairstyles they receive.

The salon would configure one or more digital cameras for taking pictures of patron hairstyles, preferably views from at least the front and one side, although all four sides is preferable. Regular patrons can then communicate their hairstyle preferences using the captured images. The user can order the images as by preference, annotate images with likes and dislikes (textually or with icons, voice, and so forth), and the user may also include information from general haircut images stored as samples of a variety of hairstyles. The user in this way can “hone” the hairstyles being received until they can be assured of getting the hairstyle that they want each time.

The patrons preferably can access their hairstyle images and information on a web site into which the image data is automatically downloaded after each image capture is performed. Additionally a system at the hair salon may be provided to allow the patron to perform the selection at the salon and to retrieve other images needed to convey their likes and dislikes.

The system also preferably allows the patron to communicate with the salon for appointments, queuing up, or just communicating other things to the stylists at the hair salon.

18. Spreadsheet Formula Synchronicity

Often the formulas within cells of a spreadsheet can be accidentally changed, such as by the insertion/deletion of rows. Presently, it is difficult to readily determine if a problem exists with any of the formulas with examining each formula.

User selection of a formula change indication within rows or columns. Selection is preferably made by engaging a difference view icon.

Example: color highlighting of the rows depending on the formula contained. i.e. for a column with five different equations—the most common shown in green with shading of light yellow, dark yellow, orange, and red as prevalence shifts from most occurrences to least occurrences.

Other changes to the cells may alternatively be utilized for indicating formula changes, such as underlining, bolding, text color changes, markings and so forth.

Other forms of differences may also be enhanced . . .

+On entering a specific type of value, such as text value cell, highlight any matching values within the column to speed the use of the same terms within a column and to maintain better consistency.

Source/destination Formatting Priority Selections

During cut-and-paste, and copy-and-paste, operation this allows the user to select a preference as to whether the formatting in the source location or the destination location, or formatting should be retained for the material being pasted.

Currently most programs format the pasted text according to the default formatting when a section of material is moved into a destination. There are times when this would be appropriate, however in many(or most) instances it is a nuisance that requires the user to perform one or a number of formatting steps to reformat the text to match the destination. This is particularly annoying when the original formatting of the document was correct in the first place.

A user preference setting wherein the user can select the “priority” of formatting for these paste style of operations. The selection may be either source, destination, default, or other. Optionally, the user is preferably allowed to select a set of formatting that is not represented in the source, destination, or default, for example when pulling recitations, or quotes from a database that are to be printed with different margins, fonts, sizing, character mode and so forth.

If destination formatting is selected, then the pasted text is inserted and reformatted automatically in accord with the formatting that exists at the insertion point. Optionally, if the formatting transitions at the insertion point, the user may be allowed to specify whether the formatting above or below the insertion point is to be used. This may be provided as a user default wherein the user need not continually enter above/below decisions.

If source formatting is selected then the pasted text just retains its prior formatting and is not converted to the default format which the user probably does not want.

The user may choose to automatically format any pasted material according to another formatting selection, such as “other”. This set of formatting may be programmed in a number of ways, such as by selecting a line having that formatting as the model, or by entering the format selections to define the “other” setting. It will be appreciated that this may be expanded to a format selection list when pasting, wherein an entire set of known or definable formats may be selected from.

The software upon detecting an attempted insertion, refers to the preference to determine how the material is to be formatted, then applies the selected formatting to the text as it is inserted into the destination. Formatting of material under software control is commonly known to one of ordinary skill in the art, wherein the details herein are not necessary.

Altering the formatting of text sections can be performed in a number of ways, and the software for implementing the above functions can be performed on any computer based system configured for performing word processing functions. The software is modified with additional user selection criterion which is referred to when a paste operation is performed, wherein the user selected formatting is applied to the text being inserted into the document. The user may be optionally prompted to allow them to alter their preset selection at the time of pasting.

19. Additional/Alternative Save Mechanism

To speed the saving of valuable application information within an application. Presently many applications provide a save feature, wherein the entire file may be saved at user discretion, or on a set periodic basis. Unfortunately, as file sizes have increased dramatically over the years, the performing of a save may require over one minute, and at times up to three or more minutes, during which the user is prevented from continuing. Users faced with this generally will turn off automatic saves or set it for an extended period, such as 30 minutes, or an hour or more. Furthermore, many applications set to perform these saves appear to lose the saved data upon certain types of system crashes occurring, wherein the user may really be sent back in time to an earlier state of the program.

Allows for a streamlined incremental form of save mechanism that may be used an alternative, or in addition to conventional saves. For example, the user may select to have full saves performed every 60 minutes with an incremental save every 3 minutes. The user may elect to perform full saves until the file size exceeds a given size and then to perform the split saves, or to rely on the incremental saves only.

The incremental save of the present invention is performed by saving user actions which are applied to a checkpointed version of the file within the application program. In addition the incremental save operations also saves any data that passed through the clipboard, or other temporary storage in route to the file associated with the application. For example, data pasted to a file from a web page, wherein the action file need not require accessing the web page, but has the data culled from the page as data stored in the action file. It will be appreciated that the action file should be configured so that it may be applied to a given file for a given application without the need of external content that is subject to change or that would untowardly increase the time required to apply the action file through the application program to the given application file.

One embodiment of incremental saves is performed as follows. As an application is running from a checkpoint, for which the application file and program state are known, the operating system saves all user actions, keyboard commands, mouse actions and the like within a form of keystroke, or action, file. An action file takes up very little room in comparison with the size of many application files. As the actions occur they are written to a buffer in memory that is flushed to disk periodically, for example every 3-5 minutes. The action file preferably contains information about the file it is associated with, for example the file name, date and time last written, and so forth. Upon performing another full write, the action file is deleted, and a new action file started. Preferably the file name of the action file will include the time the action file started and information about the application or the associated file, so that it is easier for one perusing that directory to recognize the meaning of any remnant action files.

After a system crash occurs, the system preferably checks for these action files' therefore it is best if they are located in a directory associated with the operating system. The system then opens the action files and pulls out the relevant details. The user may be asked if they want to update file XXX that was being utilized with application YYY at time=ZZZ. If so, the system opens the given file for the given application and then applies the action file to add the user actions which were not included in the last full save. If any problems arise when applying the actions, the user can be prompted for what to do with a specific action, wherein the action applications may continue. After completed, the user can peruse if the operation was a success, wherein they can choose whether to save the newly updated file or to restore the file that existed before applying the action file. Doing so assures that the user would be in no worse position in using an action file (that was implemented incorrectly) than they would be without the action file.

20. Indirect Labeling within Drawing/Text Editors

Reduce the effort involved in number or labeling elements (fields) within a drawings (document) by using allowing for the replacement of indirect fields with fields following a selected numbering, or textual, pattern. The invention is particularly well suited for use in drawings and CAD type packages wherein elements numbering or descriptions are subject to change.

The invention provides for the selective inclusion of indirect numbering or labeling within a drawing package, CAD package, or text form of editor. The most prevalent use is expected to be for providing correct numbering of drawings or CAD elements wherein the following will describe use of indirect numbering, although it should be appreciated that the invention is applicable to indirect labeling wherein text fields are changed or automatically generated according to user selected rules which replace the indirect labels applied by the user.

User selects which numbers (labels) are to be indirect. These labels may then be generated automatically by the program or the user may enter a code that indicates the order of the label in relation to the other existing labels. For example the user may enter a value b110 which relates the label to other labels such as b100 and so forth.

User selects the parameters of the remapping of the indirect addresses. The user can select the spacing and the order of how the indirect numbers (labels) are to be generated and replace the originals.

Base values—what is the number (label) based upon. Predetermined value, page number, list of values from a file, relationship calculation, and so forth.

Special formatting—such as setting the font, font size, arrangement, or relationships.

Spacing of direct numbers (labeling)—sequence spacing

User selects to generate direct numbers (labels) for all indirect numbers/labels currently in use.

User selects a “direct” view mode in which the direct labels are shown instead of the indirect labels. The document can preferably be viewed in either mode, wherein the user can add elements at any time within the schema and then have all the numbering (labeling) reordered with new direct numbers (labels).

Aspects of Invention:

+Indirect Insertion character—indirect labels may be flagged by including an identifier with text entered for a number (label). For example preceding a number entry with a “#” character or similar. Also the user may click a selection within the interface to indicate that an indirect number (label) or a series of them is to be entered.

+autobump—if user enters a new indirect number that matches an existing number then the existing number is automatically bumped up with a new indirect number or if it is text then an additional identifier is added. This simplifies the editing of indirect numbers (labels). Preferably, however, the user will space the indirect numbers apart so that additional indirect entries may be created between each existing indirect entry.

21. Incremental Software Preferences

Currently the selection of program preferences is a confusing “hit-or-miss” proposition for many users. The preference for a command may be buried in an external file, or may be controlled by an option that is contained on some other command within the SW. The present invention simplifies the methods by which the user may set command preferences within a software application.

For example in Microsoft Word the user must enter a formatting screen to select the default font and sizing, and many persons are not even aware that the option exists.

The user is often not even aware of what preference may be set for a given command. Often a user just follows the default and then laboriously changes the results on a per case basis.

Including the options within each menu would increase menu sizes and generally confuse the users. The use of line options which were popular during the days of DOS provided a ready mechanism to enter options, however, it required that one remember or lookup a variety of cryptic options prior to executing a command.

The inventions provides a method of tying preference selections to the commands to which the preference is applicable. It will be appreciated that various, often overlapping, mechanisms within the present invention may preferably, or optionally, provide this level of control. The possible preference setting (preferably with the default marked) is displayed, such as in a pop-up or in a particular portion of the display, in response to the following preference setting modes:

First Use—when a feature is first used the preference options are displayed along with the present defaults.

Beginner Use—prefer ace options remain in-force while a user is learning the relationships between commands and preferences.

Periodic refresh—the preference options are revisited periodically wherein the user can pick up a new trick here and there over a period of time. For example the user can select to pop up the menu {never, rarely, occasionally, or often} as based on the relative number of times the associated command is utilized.

Programmed preference mode—user can preferably elect a programmed preference mode, wherein their preferences for a given command may be checked and/or set for use with that command. Furthermore, the preference may be limited to certain range of documents, such as by file location, type, styles, and so forth.

Context selective preferences—the use of preferences may be set according to the context, wherein heuristic programming determines the context for properly applying the desired preferences. For example, in a table a user may want the default font set to “10 italicized”, but may have a default font set for other contexts of “12 regular”.

Learned preference settings—The program detects the changes made by the user and allows the user to set that change as a preference option.

Example—the paste command in a word processing program is often set to insert the new text with a default formatting. This is often a problem depending on the context of the operation, as the user may want the inserted text to take on the existing formatting of the document into which it is inserted, or retain its formatting from where it was extracted. The present invention allows the user to elect the context and command dependent preferences. In a learned preference setting the user just pastes the section normally and as they apply formatting to this inserted section the program determines that preference the user may desire and pops up selections wherein the user can select future preferences for the operation just performed.

It will be appreciated that the present invention is preferably capable of maintaining one or more databases of preference settings.

22. Synched Sound and Typing

Expedite referring to audio notes that were taken in association with written notes. System allows a person to take textual notes, but to be able to refer back to a recording upon which the notes are being taken. The system may be implemented on any notetaking device, such as a keyboard, PDA, motion sensing writing pen, and so forth wherein textual information is written or keyed into the device, and which incorporates, or otherwise controls, a microphone and sound recording circuits.

Markers are placed within the input text which are associated with given positions within the recording. For example, a timestamp may be associated with the sound recording which can be embedded within a control tag within the file.

In this way the user can return to areas for which notes still need to be taken, or refined based on the recorded information. Can also be used for notes that have been transcribed so that the party viewing the textual representation may click on and listen to the audio at any time as desired.

The insertion of synchronization tags may be performed automatically, such as periodically, and/or inserted at the command of the user, such as by pressing a given key, and so forth. User insertion of the synch tags, allows the voice to be structured to match the text, even if the organization of the text is altered afterward.

23. Enhanc d Stylized Writing

To simplify and speed the creation of stylized forms of writing, such as in specific fields (i.e. contracts, patents, and so forth).

Background:

Many forms of stylized writing exists, such as in the legal field, insurance, and a number of other specialized areas of writing. These documents should typically use certain phraseology, word choices, and so forth. The user in these instances is not able to use boilerplate due to the variations between one document and the next. Presently styles, such as found on word processing programs allow one to set the margins, font, and so forth but do not provide hooks that help the user create the content of the document.

Provides for the rapid creation of stylized writing. The program may be implemented for operation within any computer and desired operating system.

The user can request help at any portion of the document to bring up help that is specific to that writing style and portion of the document. The following are examples of the help provided by the program.

+Document section—A preprogrammed writing style template preferably includes names sections within a variety of document types. The operation of the software is preferably responsive to the section of the document being written. As the types of information and writing vary as per the location within the document. For example, the beginning of a contract establishes the parties, whereas the end of the contract specifies that the parties are entering into an agreement.

+Phrase help—activated by the user, such as by striking a hot-key, a mouseclick, or other user input. Phrase elements are available for the style of writing, and preferably the area of the document being executed and the optionally the context as determined by heuristics. These phrases may include both multiword phrases and single words for substituting with common or slang terms. For example, in writing a contract the phrasing as to alternate ways of designating parties would be made available wherein the user can select the phrase and continue with the writing the document. Even a neophyte to the form of writing can create a very professionally written document that matches the style of writing for that specific area.

+Problem detection—Program find inappropriate tenses, wording, and formats. For example, the use of “we”, “they”, or “I” within the description of an invention within a patent application, or slang within a legal document. Search for common errors made by practitioners within that field.

+User definable writing styles, dictionaries, thesaurus, and formats.

+Flowcharted Sections—Often each document is unique in the sections which must be included, and the writer is currently on their own to determine what sections to include and in what order to include them.

The present invention can preferably follow a writing style flowchart, wherein the sections defined in the document are selected following user interaction, such as found in following a flowchart. One example of this would be in writing an office action, or alternately in responding to an office action, wherein the writer must organize the sections in the response based upon the problems found in the application or alternatively in attempting to response to the office action itself. The user may be asked questions or to otherwise enter information about the situation, wherein the software creates templates for the various sections and allows the user to continue from that point on.

24. OFXHD Drive (Optical Fixed Head Drive)

To increase speed of disk drives by eliminating the need for the head to transition across the platter.

Currently a head unit must mechanically traverse the radius of the platter and undergo accelerations of up to 150 G's which is apparently near the G limit for a head unit. The requirement to traverse the radius is time consuming and it leads to a less reliable drive unit. The present invention eliminates the need for moving head when used with disks that may be optically read and/or written, including magnetic media that can be written and read optically.

The present invention utilizes what will be termed “optical address channels” for directing the optical energy to and from the disk surface. By way of example one or more strings of MEMs mirrors are formed along an optical channel, or fiber which are preferably connected on a radial of the disk drive. Activation of a particular MEMs is controlled electronically, for example by embedding a D-FF at each location to create a huge shift register, wherein after the data is shifted into to select the mirror to be used, a common activation pulse causes one mirror based on the data in the flip flop to activate. The mirrors preferably activate mechanically to rotate thereby intercepting the path of the beam and redirecting it, or they may operate as a shutter which changes from a transparent mode to a reflective mode to direct the beam. It will be appreciated that a number of alternative addressing schemes may be utilized such as described in pending applications on “Universal Selectable LEDs” and similar pending patents by the same inventor which are included herein by reference. A laser pulse traveling along the optical address channel is then deflected down into a lens assembly and directed at an angle toward the disk surface, which may be picked up in a similar optical address channel having MEMs lenses for picking up the reflected light. The receiving optical address channel may be configured as just a lensed channel wherein light entering any lens is directed toward one end of the fiber to be read, if the amount of spurious optical energy entering the lenses is sufficiently meager.

Multiple optical address channels may be configured on a disk surface for performing simultaneous accesses or for providing a sufficient track resolution. The track resolution may also be provided by coupling an actuator to the optical address element, such as a piezo electric actuator, wherein the optical address channel may be slid in and out so that the available MEMs can span all of the available tracks. It will be appreciated that the amount of movement will depend on the number of tracks to be covered by each MEMs device, however, the movement of the optical address channel would be expected to be on the micron level, instead of the inches in many cases being traversed by a conventional head.

It will be appreciated that one of the promising new techniques for optimizing the use of magnetic media (whose state can be read and in some instances written to optically) is through the use of raised circular portions of the disk for retaining the magnetic domains. This technique can improve domain density significantly (4-10 fold). This technique is well suited to the current approach wherein discrete paths are created by virtue of the MEMs mirrors, wherein predetermined locations on the disk surface must be read or written using the system.

It will be appreciated that the efficiency of the present system can be significantly improved if the MEMs mirrors are retained in alignment with their respective tracks wherein fewer mechanical adjustments are required wherein the optical address channel (OAC) is shifted. The temperature coefficients of the OAC therefore should be matched as closely as possible to that of the disk media itself. To compensate for any differences in length it is preferred that the present invention incorporate means for adjusting the length of the “optical address channel” (OAC). For example a heater element may be passed along the length of the OAC, which may be configured with a slightly lower tempco wherein raising its temp is required to match up with the disk surface expansion. Alternatively, a cooler may be incorporated. Alternatively, or in addition, the length may be mechanically adjusted, such as by incorporating so called “muscle wire” along the length of a somewhat compressible OAC. The OAC may be fabricated of materials such as polymeric, which provide a certain level of compressibility, and/or they may be structured to provide compliance. Signal paths along the material can be readily configured with U-shaped bends and other conventional techniques so that the compression of the material (or expansion) does not give rise to disrupting signal pathways.

FIG. 1 exemplifies an embodiment 2400 of the invention with a disk surface 2402 with three sets of optical address channels 2404a-2404c with a small read channel 2406a-2406c (both shown enlarged). An actuator 2408 is represented for modulating the location the tracks line up of the MEMs devices (represented by the circles lining up with the lines in the media—obviously enlarged for viewing) within the optical address channel (OAC). It should also be appreciated that the electronics may need to provide temperature compensation of the position of OAC position as the OAC may expand and contract differently than the disk surface. During reading this may be easily determined. A flexible form of optical couple 2412 is provided leading from a transmitter laser into the OAC, here this is depicted as a gap however, a number of better methods are available for increasing energy transfer to and from the OAC to a detector. Optionally the detector may be built onto the OAC and moved along with the rest of the OAC MEMs elements.

If an OAC actuator is utilized, it will be appreciated that the track numbering may be best ordered such that disk tracks accessible from the same position of the OAC should be mapped as adjacent tracks. In this way adjacent tracks are read without any need to move the OAC, and when moved the small amount then another series of tracks may be read. It will be appreciated that with a MEMs pitch of 1/20 of that of the disk that 1/20 of the disk could be read without any OAC movement.

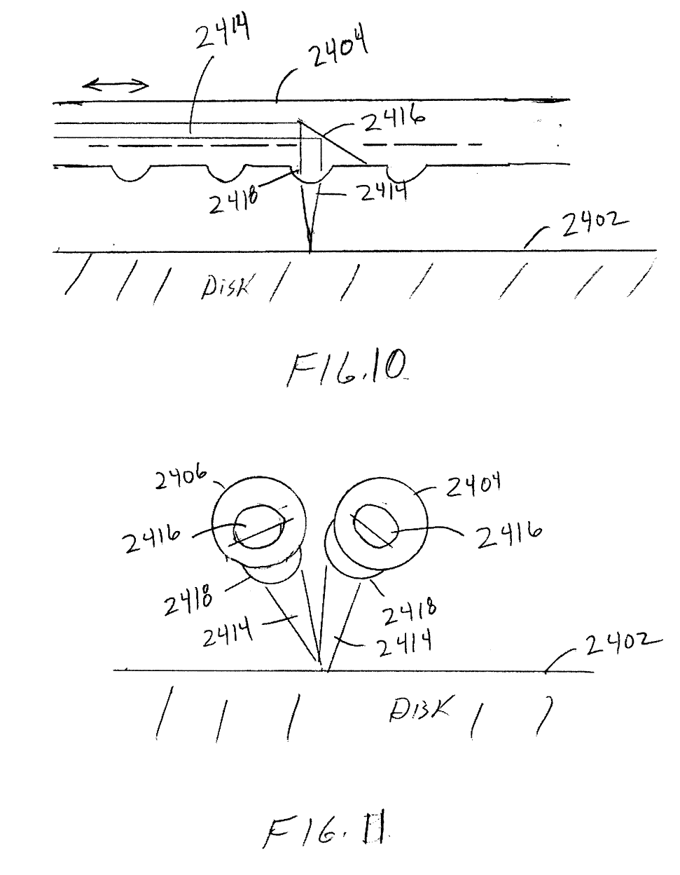

FIG. 10 depicts a side cut-away view of an OAC 2406, wherein laser light 2414 has traveled down the restricted optical path until it strikes an open MEMs mirror 2416 wherein it is directed toward the lens 2418 and disk surface 2402. The reflection from the disk surface is preferably picked up in a separate optical channel physically attached to the transmitter channel. The read channel 2406 can provide fixed reflectors or a similar array for directing light from the disk surface and lens and then into the channel towards a reader.

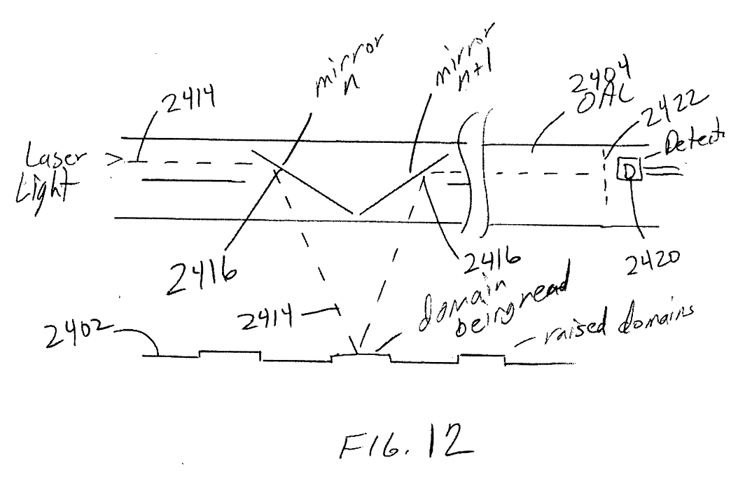

FIG. 11 depicts a simplified arrangement of a transmit channel and read channel. If the light reflected from the disk undergoes a significant frequency shift then the same channel could be used in both directions for both optical transmission and receipt.

The OAC may be configured in a number of ways to optimize reading and writing. For example, compound articulated MEMs lens may be formed along the OAC lowers to the surface, such as in that in response to optical pressure, wherein it is biased toward the disk surface wherein structuring the lens mechanism as an aerofoil can provide a counter force, wherein each lens upon activation is deployed to fly over the disk surface to increase maximum resolution and lower optical losses. Optical pressure is well known in the biological arts, such as for use as optical tweezers for moving bacteria and other small creatures. Alternative forms of biasing mechanisms may also be utilized to decrease the distance between the lens associated with a mirror element and the surface of the disk. For example a MEMs cantilever can be powered to bias the lens system toward a closer relationship with the disk surface, while the aerodynamic principles associated with establishing a given flying height are well known.

Alternatively, the lenses may be advanced toward the surface using MEMs techniques, such as coupled to the motion of the mirrors. It will be appreciated that the lenses need not fly, but may be alternatively extended to fly at a measured height above the disk based on optical focus, reference beams, and other techniques for determining height above the moving disk.

FIG. 12 illustrates an OAC 2404 wherein the mirrors 2416 may set in one of three positions allowing them to be set for directing an impinging beam, or collecting the reflection from the impinging beam. It will be appreciated that the technique has a number of advantages if the spacing between the mirrors is close enough to that of the media, wherein adjacent mirrors are sufficiently close to one another to allow directing the beam. The beam in this instance is being read by the detector 2420, and when the mirrors 2416 are rotated the beam is broken and then the detector registers the reflected light. A filter 2422 is shown represented in front of the detector, as it will be appreciated that the reflection from the front of the detector should be minimized, any conventional means may be utilized. This method eliminates the problems associated with synchronizing the relative positions of two OACs.

In order to provide an OAC in close proximity with the disk surface, it is preferable that the OAC bar be micro controllable in height above the surface. A measurement means may be used to determine the relative position of the disk surface and variations thereof. For example, a laser reference beam may be set a give distance beneath, and slightly offset from the OAC, wherein the reference beam height is adjusted with the OAC. The OAC is then lowered after spinup and the irregularities in surface height mapped according to angular position of the disk. The OAC can then be raised and lowered to match the mapping and the readings from the reference laser. Although this technique may not eliminate the need for a lens extension means, it reduces the necessary travel required.

Another advantage of the OAC technique is that an OAC may be lined up with one of multiple lasers for accommodating different media, or track areas on a given media. For example the OAC may be moved slight to the side to couple it to a different laser source.

The optical system may is preferably utilized with smaller wavelengths of light toward the UV to increase the allowable density of the disk media.

Another technique that may be utilized within this invention relates to optical fibers which have been configured to shift frequency as the light traverses the span of fiber. Using this mode of transmission along an OAC the light directed at the disk can be shifted depending on distance along the OAC, the light being read is at a frequency dependent on the location along the OAC, multiple channels may even be read simultaneously with a single transmitter laser if each mirror can be adequately illuminated.

25. Phone Billing Reminder

When billing phone time the phone (separate or integrated with computer system) can be used to trigger charge categories. Also a separate sound generation unit (also tied into TMux) During the time period over which the client is being charged a periodic sound (i.e. kaaaching!) is generated to alert the user to the charges. THIS SHOULD BE BY LAW—in a similar manner that we must alert a user to the fact that the call is to be recorded.

26. Virtual Extension Phon

To provide a number of separate virtual phone numbers for a given destination phone(s). Allows providing a number of virtual phone numbers for a given physical phone lines.

For example a home phone that is used for home, business, and calls for each of three children. The system allows the household to setup a plurality of separate phone numbers, such as 5 in this case, wherein calls to any of the lines are routed to the one phone, and information within the caller ID field used for identifying which of the five virtual phone numbers is being called.

The announcing at the destination end may be performed in a number of ways. (1) Separate destination phones that are each configured with a selector so that it will only ring if the proper caller ID matching the selector is received. Wherein the home phones operate as if they were separate phone lines on a party line. The parents are then not disrupted by the calls to children, and calls to the business are answered with the proper decorum. Furthermore, each phone may be a separate answering machine wherein each party can retrieve their own messages. (2) The phone at the destination, or a caller ID boxed equipped for identifying the encoding, announce which of the virtual phone numbers are being called, either by a display, a unique set of rings, an audio announcement and so forth. Answering machines may be adapted to respond to the virtual phone number encoding to select which mailbox a message is to be routed. Preferably the answering machine has a selector wherein one or more of the virtual extension numbers may be selected for being answered. Furthermore, the message played when answering the call is preferably responsive to which virtual extension is being called, so that the outgoing message for the business is different from the outgoing message for a teenage daughter “Sally-Ann” at the same household.

Homeowner can also prioritize calls, such as allowing calls to the primary number to go to answer machine unannounced (solicitors), wherein calls to a virtual extension for the person (given out very selectively) cause the phone to ring wherein the party answers directly.

The system must be setup at the CO wherein calls being received to any of the virtual extensions or primary number are routed through to the primary number and information as to which phone number was actually called encoded into the caller ID information, such as using 3 bits which indicate one of eight virtual extensions, (primary and seven possible virtual extensions). It will be appreciated that this function does not prevent the use of conventional caller ID. The phone company can collect extra revenue from selling the virtual extensions when they have excess numbers within the same 10K number block.

May also be referred to as a muxed phone line. Summarizing, the virtual extension allows a single phone line (i.e. residential) to be used for different purposes. For example a home business. The central office provides extra phone numbers for calling in, and routes to the same line, but with extra bits are sent w/ring—as in the “caller ID” feature to distinguish which “line” is being called. The phone announces which line has been called.

The COs often have a huge percentage of unused numbers (due to the way that numbers are allocated in blocks) and can then make use of these. This service can be billed for. Also provides a way to know WHO the call is coming in for, no need to answer a call intended for your children etc.

Answering machine can provide specific mailbox according to who was called. Can allow calls to published number to go to answering machine w/o ringing, so that owner is not disturbed by sales calls, etc. Close friends etc. can use a more exclusive number.

1. An apparatus for modifying the image stream during a video conference session to replace background portions of the image, comprising:
an image capture device;
a digital signal processor configured for operating on the video stream from said image capture device; and
programming executable on said digital signal processor for,
discerning the portion of the image representing the user from the background images,
replacing at least portions of said background image with a user selected background

2. An apparatus as recited in claim 1, wherein said background image can comprises a static image, an animated stream, or a video stream.

3. An apparatus as recited in claim 1, further comprising a control processor configured with programming for capturing user settings for the time and channel over which video and/or audio content is to be received for the system.

4. An apparatus as recited in claim 1, wherein said discerning operates in response to multiple cues selected from the group of visual object-to-background cues consisting of feature detection, edge detection, focal length, detected motion, and pattern matching from data collected during a calibration interval.

5. A system for selecting hairstyles within a hair salon or equivalent, comprising:
a digital camera adapted for obtaining images of patron hairstyles;
a user interface;
a computer operably connected to said digital camera; and
programming operable on said computer for,
identifying a patron,
retrieving previous hairstyle images of said patron from a database,
storing said hairstyle image in said data base.

6. A system as recited in claim 5, further comprising:
a web site associated with said hair salon, or equivalent, having a first part accessible to anyone and a second part accessible only to patrons;
programming on said web site for,
logging in patrons capable of accessing a second part;
retrieving a list of available images of said patron;
indicating preferences toward select hairstyles or aspects thereof.

7. A system as recited in claim 6, wherein indicating preferences comprises the sorting of images to obtain preferred hairstyles.

8. A system as recited in claim 6, wherein indicating preferences comprises associated textual comments with one or more of the images.

9. A system as recited in claim 6, wherein programming is adapted to accept patron appointments.

10. A system as recited in claim 6, wherein programming is adapted to allow said patron to communicate information as to expected day of arrival, if appointments may not be set.

11. A system as recited in claim 6, wherein programming is adapted to allow said patron to queue up for a particular day and time if conventional appointments are not available.

12. A system as recited in claim 6, wherein said web site provides a database of generally hairstyle images, and the programming on said web site allows said patron to indicate one or more images that are either indicative of a similar style or aspect of that style desired, or a style or style aspects that the patron wants to stay clear of.

13. A system as recited in claim 12, wherein said programming on said web site is adapted to accept user comment information an store it with said images thereby allowing said patron to better communicate a hairstyle to a stylist at said hair salon.

14. An apparatus for cuing stage personnel, comprising:
a transmitter capable of transmitting to a plurality of receivers;
a receiver adapted to generate an alerting signal to a stage hand, actor, actress, or other party requiring a cue, in response to a coded signal from said transmitter which directs said transmission to said receiver.

15. An apparatus as recited in claim 14, wherein said alerting signal comprises a vibration generated by said receiver to alert said party.

16. An apparatus as recited in claim 14, wherein said alerting signal comprises a sound produced by an audio transducer.

17. An apparatus as recited in claim 16, audio transducer is retained within an aural cavity mounted receiver.
